(19) United States
(12) Patent Application Publication
(10) Pub. No.: US 2017/0336684 A1
(43) Pub. Date: Nov. 23, 2017

(54) LIQUID CRYSTAL DISPLAY APPARATUS

(71) Applicant: Sharp Kabushiki Kaisha, Osaka (JP)

(72) Inventor: TSUYOSHI OKAZAKI, Osaka (JP)

(73) Assignee: Sharp Kabushiki Kaisha, Osaka (JP)

(21) Appl. No.: 15/522,136

(22) PCT Filed: Oct. 19, 2015
(86) PCT No.: PCT/JP2015/079419

§ 371 Date: Apr. 26, 2017

(30) Foreign Application Priority Data
Oct. 27, 2014 (JP) 2014-218605

(51) Int. Cl. G02F 1/1343; G02F 1/1335; G09G 3/36; G02F 1/1337; G02F 1/1368

(52) U.S. Cl. CPC G02F 1/134363; G02F 1/1337; G02F 1/133707; G02F 1/134336; G02F 1/1368; G09G 3/3648; G02F 1/133528; G09G 3/3614; G02F 2001/133531; G02F 2202/10; G09G 2320/0247; G09G 2330/02; G02F 2001/134372

(57) ABSTRACT

A liquid crystal display device (100) includes a first substrate (10), a second substrate (20) and a liquid crystal layer (30), and includes a plurality of pixels (Px). The first substrate includes a first electrode (11) and a second electrode (12) capable of generating a transverse electric field in the liquid crystal layer, and an alignment film (18) defining initial alignment axis azimuths (D1, D12), The first electrode includes at least one slit (11a). In each of the plurality of pixels, the alignment film includes a first region (18a) corresponding to the at least one slit of the first electrode and a second region (18b) corresponding to a portion of the first electrode other than the at least one slit. The initial alignment axis azimuth defined by the first region of the alignment film and the initial alignment axis azimuth defined by the second region of the alignment film are different from each other.

### TECHNICAL FIELD

The present invention relates to a liquid crystal display device, and specifically, to a liquid crystal display device of a transverse electric field mode.

### BACKGROUND ART

A TFT-type liquid crystal display device controls a voltage to be applied to an area of a liquid crystal layer that corresponds to each of pixels (electrically, such an area of the liquid crystal layer is referred to as a “liquid crystal capacitance”) via a TFT to adjust the amount of light to be transmitted through the pixel and thus to provide display. The voltage to be applied to an area of the liquid crystal layer that corresponds to each pixel has the polarity thereof inverted every certain time period. Such a method of driving a liquid crystal display device is referred to as an “AC driving method”, and is used to prevent a DC voltage from being applied to the liquid crystal layer for a long time. A reason for this is that if a DC voltage is applied to the liquid crystal layer for a long time, ions are unevenly distributed in a liquid crystal material (interface polarization) or the liquid crystal material is deteriorated, resulting in a decline in the display quality.

In this specification, a voltage to be applied to an area of the liquid crystal layer that corresponds to each of pixels (liquid crystal capacitance) will be referred to as a “pixel voltage”. A pixel voltage is a voltage applied between a pixel electrode and a counter electrode of a pixel, and is represented by a potential of the pixel electrode with respect to the potential of the counter electrode. When the potential of the pixel electrode is higher than the potential of the counter electrode, the polarity of the pixel voltage is positive, whereas when the potential of the pixel electrode is lower than the potential of the counter electrode, the polarity of the pixel voltage is negative.

In the TFT-type liquid crystal display device, the pixel electrode is connected with a drain electrode of the TFT, and is supplied with a display signal voltage from a source bus line connected with a source electrode of the TFT. A difference between the display signal voltage supplied to the pixel electrode and a counter voltage supplied to the counter electrode corresponds to the pixel voltage.

In the TFT-type liquid crystal display device, the polarity of a pixel voltage is typically inverted every frame period. Herein, the “frame period” of the TFT-type liquid crystal display device is a time period needed to supply a pixel voltage to all the pixels, and is a time period from when a gate bus line (scanning line) is selected until the next time the gate bus line is selected. The “frame period” may be called a “vertical scanning period”. The pixels are arrayed in a matrix including rows and columns. Typically, gate bus lines correspond to the rows of the pixels, and source bus lines correspond to the columns of the pixels. The pixel voltages are supplied to rows sequentially by scanning signals (gate signals) supplied to the gate bus lines.

In a conventionally general TFT-type liquid crystal display device, the frame period is 1/60 seconds (frame frequency: 60 Hz). In the case where an input video signal is, for example, an NTSC signal, which is a signal for interlace driving, one frame (frame frequency: 30 Hz) includes two fields, namely, an odd-numbered field and an even-numbered field (field frequency: 60 Hz). In the TFT-type liquid crystal display device, a pixel voltage is supplied to each of all the pixels in each of fields of the NTSC signal. Therefore, the frame period of the TFT-type liquid crystal display device is 1/60 seconds (frame frequency: 60 Hz). Recently, TFT-type liquid crystal display devices of a double driving system, in which the frame frequency is 120 Hz, or TFT-type liquid crystal display devices of a quadruple driving system, in which the frame frequency is 240 Hz, are provided in order to improve the moving image display characteristics and to perform 3D display and are commercially available. As can be seen, a TFT-type liquid crystal display device includes a driving circuit configured to determine the frame period (frame frequency) in accordance with an input video signal and supply a pixel voltage to each of all the pixels in each frame period.

Recently, liquid crystal display devices of a transverse electric field mode represented by an in plane switching (IPS) mode or a fringe field switching (FFS) mode are more and more widely used. Unlike a liquid crystal display device of a longitudinal electric field mode such as a vertical alignment (VA) mode or the like, a liquid crystal display device of a transverse electric field mode has a problem that flicker caused by polarity inversion of a pixel voltage is easily visible. This is considered to occur because when the alignment of liquid crystal molecules is changed to cause bend deformation or splay deformation, alignment polarization caused by asymmetrical alignment of the liquid crystal molecules (such alignment polarization is referred to as “flexoelectric polarization”) occurs.

Patent Document 1 discloses a liquid crystal display device that sets flexoelectric coefficients e₁₁ and e₃₃ and elastic moduli K₁₁ and K₃₃ of the liquid crystal material to predetermined ranges and thus suppresses generation of flicker caused by flexoelectric polarization.

Recently, the present applicant produces and sells a liquid crystal display device of low power consumption including TFTs including an oxide semiconductor layer (e.g., In—Ga—Zn—O-based semiconductor layer). A TFT including an In—Ga—Zn—O-based semiconductor layer has a high mobility (more than 20 times the mobility of an a-SiTFT) and a low leak current (less than 1/100 of the leak current of an a-SiTFT). In the case where a TFT including an In—Ga—Zn—O-based semiconductor layer is used as a pixel TFT, the power consumption is decreased by using “idle driving” (also referred to as “low frequency driving”) because the leak current is low.

The idle driving method is described in, for example, Patent Document 2. Patent Document 2 is incorporated herein by reference in its entirety. With the idle driving method, a cycle of writing an image for one frame period ( 1/60 seconds) by usual 60 Hz driving (one frame period: 1/60 seconds) and then not writing an image in the following 59 frame periods (59/60 seconds) is repeated. The idle driving, by which an image is written once each second, may also be referred to as “1 Hz driving”. Herein, the “idle driving” refers to a driving method by which an idle period is longer than a period in which an image is written, or low frequency driving by which the frame frequency is less than 60 Hz.

Ease of visibility of flicker depends on the frequency. For example, a change in luminance that is not much disturbing at 60 Hz is easily recognized visually as flicker at a frequency of less than 60 Hz, especially, at a frequency of 30 Hz or less. It is known that especially when the luminance is changed at a frequency of, or around, 10 Hz, flicker is much disturbing.

### CITATION LIST

### Patent Literature

Patent Document 1: Japanese Laid-Open Patent Publication No. 2010-282037

Patent Document 2: WO2013/008668

### SUMMARY OF INVENTION

### Technical Problem

The present inventor adopted the above-described idle driving to a liquid crystal display device of a transverse electric field mode and found that flicker that was not dealt with by the technology disclosed in Patent Document 1 occurred.

The present invention made in light of the above-described problem has an object of providing a liquid crystal display device of a transverse electric field mode which does not allow flicker to be easily recognized visually even when being driven at a frequency of less than 60 Hz.

### Solution to Problem

A liquid crystal display device in an embodiment according to the present invention includes a first substrate and a second substrate provided so as to face each other; and a liquid crystal layer provided between the first substrate and the second substrate. The liquid crystal display device including a plurality of pixels arrayed in a matrix. The first substrate includes a first electrode and a second electrode capable of generating a transverse electric field in the liquid crystal layer, and an alignment film provided so as to be in contact with the liquid crystal layer, the alignment film defining an initial alignment axis azimuth as an alignment axis azimuth of a liquid crystal molecule while no electric field is applied to the liquid crystal layer; the first electrode includes at least one slit; in each of the plurality of pixels, the alignment film includes a first region corresponding to the at least one slit of the first electrode and a second region corresponding to a portion of the first electrode other than the at least one slit; and the initial alignment axis azimuth defined by the first region of the alignment film and the initial alignment axis azimuth defined by the second region of the alignment film are different from each other.

In an embodiment, the liquid crystal display device according to the present invention further includes a pair of polarization plates facing each other while having at least the liquid crystal layer therebetween. The pair of polarization plates are located in a crossed-Nicols state; and a polarization axis of one of the pair of polarization plates is approximately parallel to either the initial alignment axis azimuth defined by the first region or the initial alignment axis azimuth defined by the second region that makes a larger angle with a direction in which the at least one slit extends.

In an embodiment, among an angle made by the initial alignment axis azimuth defined by the first region and a direction in which the at least one slit extends and an angle made by the initial alignment axis azimuth defined by the second region and the direction in which the at least one slit extends, the larger angle is 4° or greater and 15° or less, and the smaller angle is 3° or greater and 14° or less.

In an embodiment, the first electrode is provided on the second electrode with a dielectric layer being provided between the first electrode and the second electrode; and the first substrate includes the alignment film, the first electrode, the dielectric layer and the second electrode provided sequentially in this order from the side of the liquid crystal layer.

In an embodiment, the liquid crystal display device according to the present invention is allowed to perform idle driving by which one frame includes a signal supply period in which a display signal voltage is supplied to each of the plurality of pixels and an idle period in which no display signal voltage is supplied to each of the plurality of pixels.

In an embodiment, the first substrate includes a thin film transistor provided in each of the plurality of pixels; and the thin film transistor includes a semiconductor layer containing an oxide semiconductor.

In an embodiment, the oxide semiconductor contains an In—Ga—Zn—O-based semiconductor.

In an embodiment, the In—Ga—Zn—O-based semiconductor includes a crystalline portion.

### Advantageous Effects of Invention

An embodiment of the present invention provides a liquid crystal display device of a transverse electric field mode which does not allow flicker to be easily recognized visually even when being driven at a frequency of less than 60 Hz.

### BRIEF DESCRIPTION OF DRAWINGS

FIG. 1(a) is a plan view schematically showing a liquid crystal display device 100 in an embodiment according to the present invention, and FIG. 1(b) is a cross-sectional view of FIG. 1(a) taken along line 1B-1B′ in FIG. 1(a).

FIG. 2(a) is a plan view showing a portion corresponding to region R2A in FIG. 1(a), and FIG. 2(b) is a cross-sectional view of FIG. 1(a) taken along line 2B-2B′ in FIG. 1(a).

FIG. 3 shows a direction in which a liquid crystal molecule LC in the liquid crystal display device 100 rotates when a voltage is applied.

FIG. 4 is a graph showing a time-wise change in the normalized luminance in the case where idle driving is performed on a liquid crystal display device of a transverse electric field.

FIG. 5(a) and FIG. 5(b) are respectively a plan view and a cross-sectional view schematically showing a liquid crystal display device 900 in a comparative example, FIG. 5(c) is a graph showing a luminance profile obtained when a positive pixel voltage is applied (at the time of 100 msec.) and a luminance profile obtained immediately after the polarity of the pixel voltage is inverted from positive to negative (at the time of 106 msec.), and FIG. 5(d) is a graph showing a luminance profile obtained when a negative pixel voltage is applied (at the time of 200 msec.) and a luminance profile obtained immediately after the polarity of the pixel voltage is inverted from negative to positive (at the time of 206 msec.).

FIG. 6 is a graph showing the VT characteristic (relationship between the pixel voltage and the normalized transmittance) obtained when the initial alignment angle is 3°, 7°, 11° and 15°.

FIG. 7 is a graph showing the response characteristic (relationship between the time and the normalized transmittance) obtained when the initial alignment angle is 3°, 7°, 11° and 15°.

FIG. 8 shows another structure of the liquid crystal display device 100 and is a plan view showing a portion corresponding to the region R2A in FIG. 1(a).

FIG. 9 shows a preferable positional arrangement of a pair of polarization plates included in the liquid crystal display device 100.

FIG. 10 is a graph showing the VT characteristic in the case where an initial alignment angle θ1 in first regions 18a of an alignment film 18 is 3°, an initial alignment angle θ2 in a second regions 18b is 15°, and a polarization axis a1 of one of the pair of polarization plates is approximately parallel to initial alignment axis azimuth D2 defined by second regions 18b.

FIG. 11 is a graph showing the VT characteristic (relationship between the pixel voltage and the normalized transmittance) when the initial alignment angle is 3°, 7°, 11°, 15° and 19°.

FIG. 12(a) is a graph showing a luminance profile obtained when a positive pixel voltage is applied (at the time of 100 msec.) and a luminance profile obtained immediately after the polarity of the pixel voltage is inverted from positive to negative (at the time of 106 msec.) in example 1, and FIG. 12(b) is a graph showing a difference between the luminance profile obtained at the time of 100 msec. and the luminance profile obtained at the time of 106 msec. of each of the liquid crystal display device 900 in the comparative example and the liquid crystal display device in example 1.

FIG. 13(a) is a graph showing a luminance profile obtained when a negative pixel voltage is applied (at the time of 200 msec.) and a luminance profile obtained immediately after the polarity of the pixel voltage is inverted from negative to positive (at the time of 206 msec.) in example 1, and FIG. 13(b) is a graph showing a difference between the luminance profile obtained at the time of 200 msec. and the luminance profile obtained at the time of 206 msec. of each of the liquid crystal display device 900 in the comparative example and the liquid crystal display device in example 1.

FIG. 14 is a graph showing time-wise changes in the normalized luminance in the case where idle driving is performed at 10 Hz on the liquid crystal display device 900 in the comparative example and the liquid crystal display device in example 1.

FIG. 15 is a graph showing flicker ratios in the case where idle driving is performed at 10 Hz on the liquid crystal display device 900 in the comparative example and the liquid crystal display device in example 1.

FIG. 16(a) is a graph showing a luminance profile obtained when a positive pixel voltage is applied (at the time of 100 msec.) and a luminance profile obtained immediately after the polarity of the pixel voltage is inverted from positive to negative (at the time of 106 msec.) in example 2, and FIG. 16(b) is a graph showing a difference between the luminance profile obtained at the time of 100 msec. and the luminance profile obtained at the time of 106 msec. of each of the liquid crystal display device 900 in the comparative example and the liquid crystal display device in example 2.

FIG. 17(a) is a graph showing a luminance profile obtained when a negative pixel voltage is applied (at the time of 200 msec.) and a luminance profile obtained immediately after the polarity of the pixel voltage is inverted from negative to positive (at the time of 206 msec.) in example 2, and FIG. 17(b) is a graph showing a difference between the luminance profile obtained at the time of 200 msec. and the luminance profile obtained at the time of 206 msec. of each of the liquid crystal display device 900 in the comparative example and the liquid crystal display device in example 2.

FIG. 18(a) and FIG. 18(b) is a graph showing time-wise changes in the normalized luminance in the case where idle driving is performed at 10 Hz on the liquid crystal display device 900 in the comparative example and the liquid crystal display device in example 2.

FIG. 19 is a graph showing flicker ratios in the case where idle driving is performed at 10 Hz on the liquid crystal display device 900 in the comparative example and the liquid crystal display device in example 2.

FIG. 20 shows an optical alignment process performed on the alignment films 18 and 28.

FIG. 21(a) and FIG. 21(b) each show a rubbing process performed on the alignment films 18 and 28.

FIG. 22(a) and FIG. 22(b) are each a cross-sectional view schematically showing another structure of the liquid crystal display device 100 in an embodiment according to the present invention.

FIG. 23(a) is an isometric view showing “alignment axis azimuth”, “alignment azimuth” and “alignment direction”, and FIG. 23(b) is an isometric view showing polar angle θ and azimuthal angle φ defined with respect to a main surface of an alignment film.

### DESCRIPTION OF EMBODIMENTS

Hereinafter, an embodiment according to the present invention will be described with reference to the drawings. In the following description, the alignment directions of the liquid crystal molecules need to be described correctly. Thus, terms expressing the “alignment directions” will be defined. In general, a “direction” is expressed by a vector in a three-dimensional space. However, there are directions defined in a display plane (in a two-dimensional plane), and there are cases where a positive direction and a negative direction (two directions opposite from each other by 180°) do not need to be distinguished from each other.

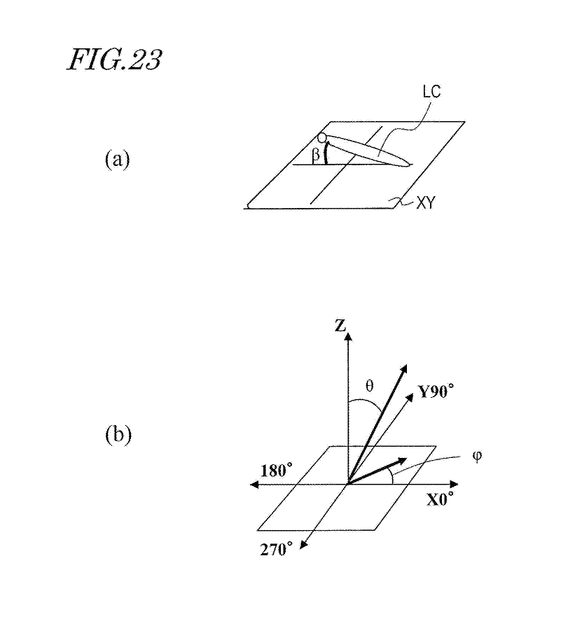

First, with reference to FIG. 23(a) and FIG. 23(b), terms “alignment axis azimuth”, “alignment azimuth” and “alignment direction” in this specification will be described. As shown in FIG. 23(a), a liquid crystal molecule LC is typically aligned to have a predetermined pretilt angle with respect to a main surface of an alignment film (XY plane). In this state, a vector directed from an end of the liquid crystal molecule LC that is closer to the XY plane toward an end of the liquid crystal molecule LC that is farther from the XY plane (end represented by the white circle in FIG. 23(a)) will be discussed. An orientation of a component of the vector in the XY plane (shadow projected in the XY plane) will be referred to as an “alignment azimuth”. The “alignment azimuth” may be represented in a range of 0° to 360° by use of azimuthal angle φ shown in FIG. 23(b). An orientation of a straight line defined by the “alignment azimuth” and an alignment azimuth different from the “alignment azimuth” by 180° (opposite orientation) will be referred to as an “alignment axis azimuth”. An expression that the “alignment axis azimuth is the same” may indicate that the alignment azimuth is the same or that the alignment azimuth is different by 180°. The term “alignment direction” refers to a three-dimensional direction (direction of a longer axis of the liquid crystal molecule, and is a direction in consideration of polar angle θ shown in FIG. 23(b).

Hereinafter, an embodiment according to the present invention will be described with reference to the drawings. In the following embodiment, an FFS-mode liquid crystal display device will be described as an example, but the embodiment according to the present invention is not limited to an FFS-mode liquid crystal display device and may be applicable to an ISP-mode liquid crystal display device.

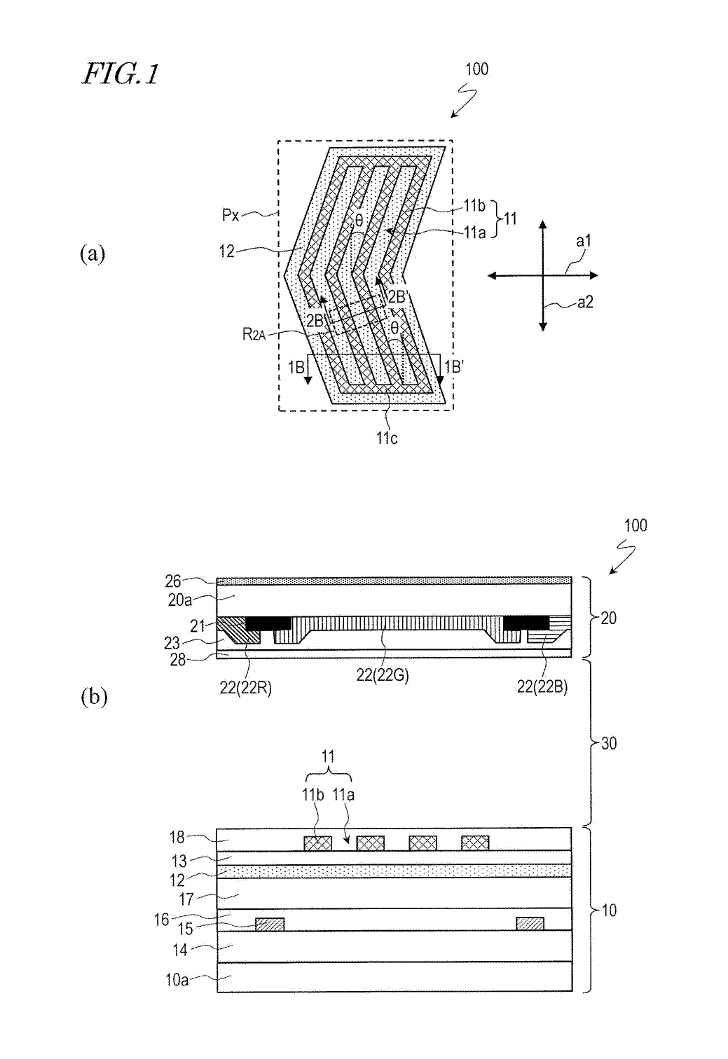

FIG. 1(a) and FIG. 1(b) each show a liquid crystal display device 100 in an embodiment according to the present invention. FIG. 1(a) and FIG. 1(b) are respectively a plan view and a cross-sectional view schematically showing the liquid crystal display device 100. FIG. 1(a) shows a region corresponding to one pixel Px in the liquid crystal display device 100. FIG. 1(b) is a cross-sectional view of FIG. 1(a) taken along line 1B-1B′.

The liquid crystal display device 100 includes an active matrix substrate (first substrate) 10 and a counter substrate (second substrate) 20 provided so as to face each other, and a liquid crystal layer 30 provided between the active matrix substrate 10 and the counter substrate 20. The liquid crystal display device 100 includes a plurality of pixels Px arrayed in a matrix.

Although not shown, the liquid crystal display device 100 further includes a pair of polarization plates. The pair of polarization plates are located so as to face each other while having at least the liquid crystal layer 30 therebetween (typically, on the side of the active matrix substrate 10 opposite to the liquid crystal layer 30 and on the side of the counter substrate 20 opposite to the liquid crystal layer 30). These polarization plates are located in a crossed-Nicols state. Namely, as shown in FIG. 1(a), the polarization axis (absorption axis) a1 of one of the pair of polarization plates and a polarization axis (absorption axis) a2 of the other polarization plate are generally perpendicular to each other.

The active matrix substrate 10 includes a first electrode 11 and a second electrode 12 capable of generating a transverse electric field in the liquid crystal layer 30, and an alignment film 18 provided so as to be in contact with the liquid crystal layer 30. One of the first electrode 11 and the second electrode 12 is a pixel electrode, and the other electrode is a common electrode. In this example, the first electrode 11 is a pixel electrode, and the second electrode 12 is a common electrode.

The first electrode 11 is electrically connected with a drain electrode of a thin film transistor (TFT) provided in each of the pixels Px, and is supplied with a display signal voltage via the TFT. The first electrode 11 is formed of a transparent conductive material (e.g., ITO).

The first electrode 11 includes at least one slit 11a (a plurality of slits 11a in the example shown in FIG. 1) and a plurality of lengthy electrode portions (branches) 11b. The plurality of lengthy electrode portions 11b extend approximately parallel to each other. Each of the slits 11a is formed between two adjacent lengthy electrode portions 11b. The lengthy electrode portions 11b are electrically connected with each other by a connection portion (stem) 11c.

In the example shown in FIG. 1(a), the slits 11a and the lengthy electrode portions 11b extend in different directions in an upper half and a lower half of the pixel Px. Specifically, the slits 11a and the lengthy electrode portions 11b extend in a direction inclined by a predetermined angle θ clockwise with respect to a vertical direction in the display plane in the upper half and extend in a direction inclined by the predetermined angle θ counterclockwise with respect to the vertical direction in the display plane in the lower half.

The number of the slits 11a and the number of the lengthy electrode portions 11b are not limited to those shown in the figure. There is no specific limitation on the width of the slits 11a or the width of the lengthy electrode portions 11b.

The first electrode 11 is provided on the second electrode 12 with a dielectric layer 13 being provided between the first electrode 11 and the second electrode 12. Namely, the active matrix substrate 10 includes the alignment film 18, the first electrode 11, the dielectric layer 13 and the second electrode 12 provided sequentially in this order from the side of the liquid crystal layer 30. The dielectric layer 13 is formed of, for example, an inorganic insulating material.

The second electrode 12 is supplied with a common voltage. The second electrode 12 is typically a flat electrode (electrode with no slits or the like). The second electrode 12 is formed of a transparent conductive material (e.g., ITO).

The alignment film 18 defines an initial alignment axis azimuth, which is an alignment axis azimuth of a liquid crystal molecule while no electric field is applied to the liquid crystal layer 30. As described below in detail, the alignment film 18 includes a plurality of regions defining different initial alignment axis azimuths from each other.

In this embodiment, the alignment film 18 is an optical alignment film, and acts as a horizontal alignment film mainly defining the alignment azimuth of the liquid crystal molecule. A pretilt angle of the liquid crystal molecule defined by the alignment film 18 is typically set to 1° or less. Preferably, the pretilt angle of the liquid crystal molecule is 0.1° or greater and 1.0° or less.

In this specification, an “optical alignment film” refers to an alignment film provided with an alignment control force by being irradiated with light (e.g., polarized ultraviolet rays). WO2009/157207 describes a liquid crystal display device including an optical alignment film. WO2009/157207 describes a technology that forms an optical alignment film by, for example, irradiating, with light, an alignment film formed of a polymer including a main chain of polyimide and a side chain containing a cinnamate group as a photoreactive functional group. WO2009/157207 is incorporated herein by reference in its entirety.

The components of the active matrix substrate 10 are supported by a transparent insulating plate (e.g., glass plate) 10a. On the plate 10a, a gate metal layer is provided. The gate metal layer includes a gate electrode of the TFT and a scanning line (gate bus line) electrically connected with the gate electrode (neither the gate electrode nor the scanning line is shown). The scanning line supplies a scanning signal voltage to the TFT.

A gate insulating layer 14 is provided so as to cover the gate metal layer. On the gate insulating layer 14, an oxide semiconductor layer (not shown) is provided as an active layer of the TFT. The semiconductor layer formed of an oxide semiconductor is used to provide element characteristics (off characteristics) suitable to realize low frequency driving.

The oxide semiconductor layer contains, for example, a semiconductor based on an In—Ga—Zn—O (hereinafter, referred to simply as an “In—Ga—Zn—O-based semiconductor). The In—Ga—Zn—O-based semiconductor is a three-element oxide containing In (indium), Ga (gallium) and Zn (zinc). There is no limitation on the ratio (composition ratio) of In, Ga and Zn. The ratio is, for example, In:Ga:Zn=2:2:1, In:Ga:Zn=1:1:1, In:Ga:Zn=1:1:2, or the like. In this embodiment, the oxide semiconductor layer may be an In—Ga—Zn—O-based semiconductor layer containing In, Ga and Zn at a ratio of, for example, In:Ga:Zn=1:1:1.

A TFT including an In—Ga—Zn—O-based semiconductor layer has a high mobility (more than 20 times the mobility of an a-SiTFT) and a low leak current (less than 1/100 of the leak current of an a-SiTFT), and therefore, is preferably used as a driving TFT or a pixel TFT. Use of a TFT including an In—Ga—Zn—O-based semiconductor layer significantly decreases the power consumption of the liquid crystal display device 100.

The In—Ga—Zn—O-based semiconductor may be amorphous or may include a crystal portion and may be crystalline. A preferable crystalline In—Ga—Zn—O-based semiconductor is a crystalline In—Ga—Zn—O-based semiconductor in which c axis is aligned approximately vertical with respect to the layer surface. Such a crystalline structure of the In—Ga—Zn—O-based semiconductor is disclosed in, for example, Japanese Laid-Open Patent Publication No. 2012-134475. Japanese Laid-Open Patent Publication No. 2012-134475 is incorporated herein by reference in its entirety.

An oxide semiconductor layer may contain another oxide semiconductor instead of the In—Ga—Zn—O-based semiconductor. The oxide semiconductor layer may contain, for example, a Zn—O-based semiconductor (ZnO), an In—Zn—O-based semiconductor WO (registered trademark)), a Zn—Ti—O-based semiconductor (ZTO), a Cd—Ge—O-based semiconductor, a Cd—Pb—O-based semiconductor, CdO (cadmium oxide), an Mg—Zn—O-based semiconductor, an In—Sn—Zn—O-based semiconductor (e.g., In₂O₃—SnO₂—Zn—O), an In—Ga—Sn—O-based semiconductor, or the like.

On the oxide semiconductor layer, a source metal layer is provided. The source metal layer includes a source electrode and the drain electrode of the TFT (neither is shown) and a signal line (source bus line) 15 electrically connected with the source electrode. The signal line 15 supplies a display signal voltage to the TFT.

A protective layer 16 is provided so as to cover the source metal layer. The protective layer 16 is formed of, for example, an inorganic insulating material. On the protective layer 16, an organic interlayer insulating layer 17 is provided. The organic interlayer insulating layer 17 is formed of, for example, a photosensitive resin material.

The second electrode 12, the dielectric layer 13, the first electrode 11 and the alignment film 18 are stacked sequentially in this order on the organic interlayer insulating layer 17.

The counter substrate 20 includes a light blocking layer 21, a color filter layer 22 and an alignment film 28. The alignment film 28 is provided so as to be in contact with the liquid crystal layer 30.

The light blocking layer (also referred to as a “black matrix”) 21 is formed of, for example, a photosensitive black resin material.

The color filter layer 22 includes a red color filter 22R, a green color filter 22G and a blue color filter 22B. The red color filter 22R, the green color filter 22G and the blue color filter 22B are formed of, for example, a photosensitive colored resin material.

The alignment azimuth of the liquid crystal molecule defined by the alignment film 28 is parallel or antiparallel to the alignment azimuth of the liquid crystal molecule defined by the alignment film 18. In this embodiment, the alignment film 28 is an optical alignment film and acts as a horizontal alignment film mainly defining the alignment azimuth of the liquid crystal molecule. A pretilt angle of the liquid crystal molecule defined by the alignment film 28 is also typically set to 1° or less. Preferably, the pretilt angle of the liquid crystal molecule defined by the alignment film 28 is 0.1° or greater and 1.0° or less.

In this embodiment, an organic flattening layer 23 is provided so as to cover the light blocking layer 21 and the color filter layer 22. On the organic flattening layer 23, the alignment film 28 is provided. The organic flattening layer 23 is formed of, for example, a photosensitive resin material.

The components of the counter substrate 20 are supported by an insulating transparent plate (e.g., glass plate) 20a. On a surface of the plate 20a opposite to the liquid crystal layer 30, an antistatic transparent conductive layer 26 is provided. The transparent conductive layer 26 is given a potential of, for example, 0 V.

The liquid crystal layer 30 contains a nematic liquid crystal material having positive dielectric anisotropy. The liquid crystal molecules in the liquid crystal layer 30 are aligned approximately horizontal by the alignment control forces of the alignment films 18 and 28.

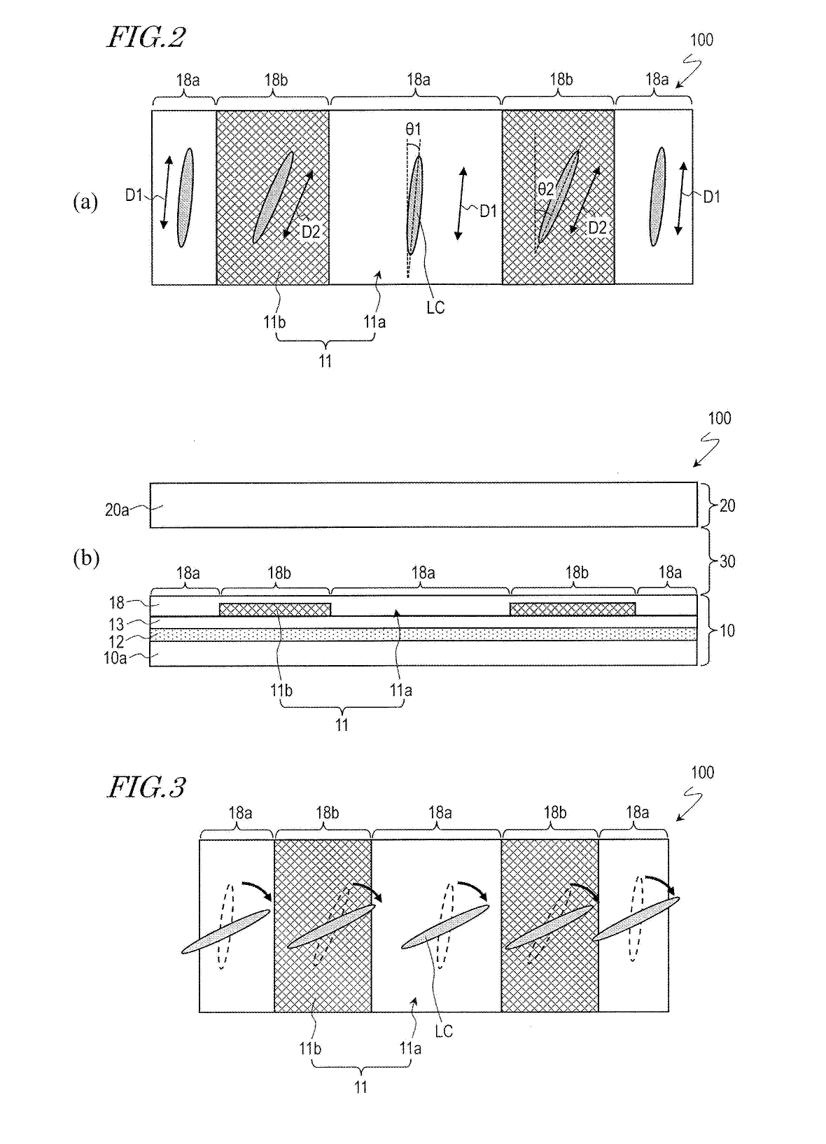

As described above, the alignment film 18 includes, in each pixel Px, a plurality of regions defining different initial alignment axis azimuths from each other. Hereinafter, this will be described with reference to FIG. 2(a) and FIG. 2(b). FIG. 2(a) is a plan view showing a portion corresponding to region R2A shown in FIG. 1(a). FIG. 2(b) is a cross-sectional view of FIG. 1(a) taken long line 2B-2B′ in FIG. 1(a). FIG. 2(a) and FIG. 2(b) omit a part of the components shown in FIG. 1(a) and FIG. 1(b).

As shown in FIG. 2(a) and FIG. 2(b), in each pixel Px, the alignment film 18 includes first regions 18a corresponding to the slits 11a of the first electrode 11 and second regions 18b corresponding to portions other than the slits 11a (mainly corresponding to the lengthy electrode portions 11b).

An initial alignment axis azimuth D1 of the liquid crystal molecule LC defined by the first regions 18a of the alignment film 18 and an initial alignment axis azimuth D2 of the liquid crystal molecule LC defined by the second regions 18b of the alignment film 18 are different from each other. In the example shown in FIG. 2(a), an angle θ1 made by the initial alignment axis azimuth D1 defined by the first regions 18a and a direction in which the slits 11a extend (hereinafter, such an angle may be referred to as “initial alignment angle”) is smaller than an angle θ2 made by the initial alignment axis azimuth D2 defined by the second regions 18b and the direction in which the slits 11a extend. The initial alignment angle θ1 in the first regions 18a is, for example, 3°, and the initial alignment angle θ2 in the second regions 18b is, for example, 15°.

As described above, the alignment film 18 includes two types of regions defining the initial alignment axis azimuths D1 and D2 different from each other (namely, includes the first regions 18a and the second regions 18b). In the case where the alignment film 28 is provided in the counter substrate 20 like in this embodiment, the alignment azimuth defined by the alignment film 28 is, in regions corresponding to the first regions 18a of the first alignment film 18, parallel or antiparallel to the alignment azimuth defined by the first regions 18a, and is, in regions corresponding to the second regions 18b of the first alignment film 18, parallel or antiparallel to the alignment azimuth defined by the second regions 18b. Namely, the regions of the alignment film 28 corresponding to the slits 11a of the first electrode 11, and the regions of the alignment film 28 corresponding to the portions other than the slits 11a, define different alignment azimuths from each other.

When a voltage is applied between the first electrode 11 and the second electrode 12, a transverse electric field (fringe field) is generated in a direction perpendicular to the direction in which the slits 11a extend. As shown in FIG. 3, the liquid crystal molecules LC rotate such that the alignment directions thereof become closer to the direction of the transverse electric field. FIG. 3 shows how the alignment directions of the liquid crystal molecules LC in the region R2A shown in FIG. 1(a) are changed. Namely, FIG. 3 shows how the alignment directions in the lower half of the pixel Px are changed. As can be seen from FIG. 3, the liquid crystal molecules LC rotate clockwise in the lower half of the pixel Px when the voltage is applied. By contrast, in the upper half of the pixel Px, the liquid crystal molecules LC rotate counterclockwise when the voltage is applied.

The liquid crystal display device 100 may perform idle driving. Idle driving (by which image data is rewritten at a frequency of, for example, 1 to several hertz) may be performed while, for example, a still image is displayed, so that the power consumption is significantly decreased.

In a general liquid crystal display device driven at 60 Hz, a display signal voltage is supplied to the pixel every vertical scanning period (about 1/60 seconds). Namely, with 60 Hz driving, a display signal is applied to the pixel 60 times per second.

By contrast, with the idle driving, a display signal voltage is supplied to the pixel in a predetermined vertical scanning period, and no display signal voltage is supplied to the pixel in a single or a plurality of vertical scanning periods after the predetermined vertical scanning period. Namely, with the idle driving, one frame includes a signal supply period in which a display signal voltage is supplied to each pixel and an idle period in which no display signal voltage is supplied to each pixel.

For example, idle driving of a driving frequency of 1 Hz may be performed by not supplying any display signal to the pixel for 59 vertical scanning periods (59/60 seconds) after a display signal voltage is supplied to the pixel in one vertical scanning period (one vertical scanning period of 60 Hz driving: 1/60 seconds). In the case where the idle driving is performed, a voltage may be supplied in a plurality of vertical scanning periods in order to apply a desirable display signal voltage to the pixel. For example, a display signal voltage may be supplied to the first three vertical scanning periods, and then the idle driving may be performed in 57 vertical scanning periods after the first three vertical scanning periods.

As can be seen from the above, in this specification, a period assigned to supply a display signal to the pixel is referred to as “one frame”. With 1 Hz idle driving, one frame include 60 vertical scanning periods. Within one frame, a signal supply period and an idle period are appropriately set. With 60 Hz driving, one frame corresponds to one vertical scanning period. As can be understood from the above, in this specification, the term “driving frequency” corresponds to a reciprocal of one frame period (seconds). For example, in the case where the driving frequency is set to 10 Hz by the idle driving, one frame period is 0.1 seconds.

As described above, in the liquid crystal display device 100 in this embodiment, the alignment film 18 includes, in each pixel Px, two types of regions (first regions 18a and second regions 18b) defining the initial alignment axis azimuths D1 and D2 different from each other. Therefore, even if the liquid crystal display device 100 is driven at a frequency less than 60 Hz, flicker caused by flexoelectric polarization is made difficult to be visually recognized. Hereinafter, the reason for this will be described. Prior to the reason, flexoelectric polarization and flicker caused by the flexoelectric polarization will be described.

In a nematic liquid crystal material, liquid crystal molecules each have a permanent dipole moment and are polarized, but macroscopic polarization does not occur in an equilibrium state due to the symmetrical alignment of the liquid crystal molecules. However, when the liquid crystal molecules are arrayed so as to match the alignment directions thereof by a rapid change in the electric field distribution, local splay alignment or bend alignment occurs (namely, the symmetrical alignment of the liquid crystal molecules is destroyed) and macroscopic polarization occurs. Such a polarization (polarization caused by a flexoelectric effect) is the flexoelectric polarization.

Patent Document 1 describes that in an FFS-mode liquid crystal display device, the transmittance when a positive voltage is applied to the liquid crystal layer and the transmittance when a negative voltage is applied to the liquid crystal layer are different from each other because of the flexoelectric polarization. According to Patent Document 1, the flexoelectric polarization is caused by a local splay alignment (splay alignment at, or in the vicinity of, an interface between the alignment film in the active matrix substrate and the liquid crystal layer) caused by the competition between the alignment control force made by an electric field (represented by arcked line of electric force) generated in the liquid crystal layer and the alignment control force made by the alignment film in the active matrix substrate. The orientation of the flexoelectric polarization is inverted along with the inversion of the polarity of the voltage applied to the liquid crystal layer. Therefore, the dark line in the pixel (generated by the flexoelectric polarization) is moved along with the inversion of the orientation of the flexoelectric polarization, and thus flicker is visually recognized. Patent Document 1 describes that the flicker may be suppressed by setting flexoelectric coefficients en and e₃₃ and elastic moduli K₁₁ and K₃₃ of the liquid crystal material to predetermined ranges.

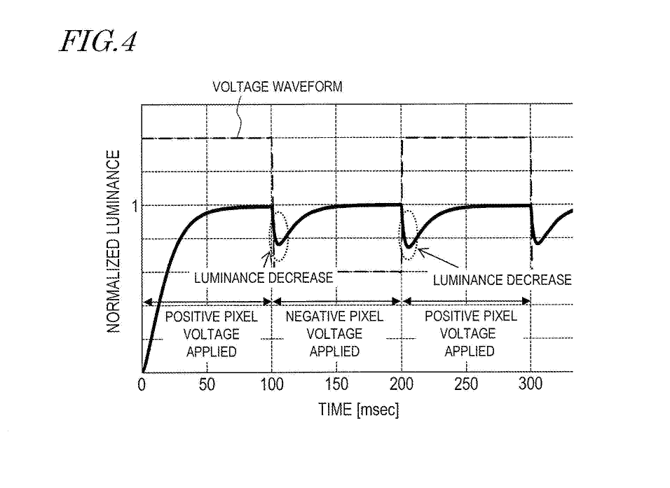

However, when the present inventor applied the above-described idle driving to a liquid crystal display device of a transverse electric field mode, flicker not dealt with by the technology disclosed in Patent Document 1 was found to be generated. FIG. 4 shows a time-wise change in the normalized luminance when idle driving is performed on a liquid crystal display device of the transverse electric field mode. FIG. 4 also shows a waveform of the pixel voltage. In the example shown in FIG. 4, the driving frequency is 10 Hz (i.e., one frame period is 100 msec.) because of the idle driving, and the polarity of the pixel voltage is inverted every 100 msec. Specifically, a positive pixel voltage is applied in a first frame (0 to 100 msec.), a negative pixel voltage is applied in a second frame (100 msec. to 200 msec.), and a positive pixel voltage is applied in a third frame (200 msec. to 300 msec.).

It is seen from FIG. 4 that the luminance is decreased at the time of polarity inversion. This luminance decrease is visually recognized as flicker. The luminance is decreased like a downward horn at the time of polarity inversion, and thus this phenomenon will also be referred to as a “downward horn response”.

The present inventor made a simulation. Even when flexoelectric coefficients e₁₁ and e₃₃ and elastic moduli K₁₁ and K₃₃ of the liquid crystal material were set to the ranges disclosed in Patent Document 1, the above-described flicker phenomenon (downward horn response) was not improved.

Hereinafter, a reason why the downward horn response occurs will be described.

Flexoelectric polarization accompanies a potential difference. Therefore, the rotation amount of a liquid crystal molecule when the voltage is applied is obtained by superimposing the rotation amount corresponding to the potential difference caused by the flexoelectric polarization on the rotation amount caused by the applied electric field. Thus, there are liquid crystal molecules rotated significantly and liquid crystal molecules rotated little in the same pixel. This appears as a brightness/darkness difference.

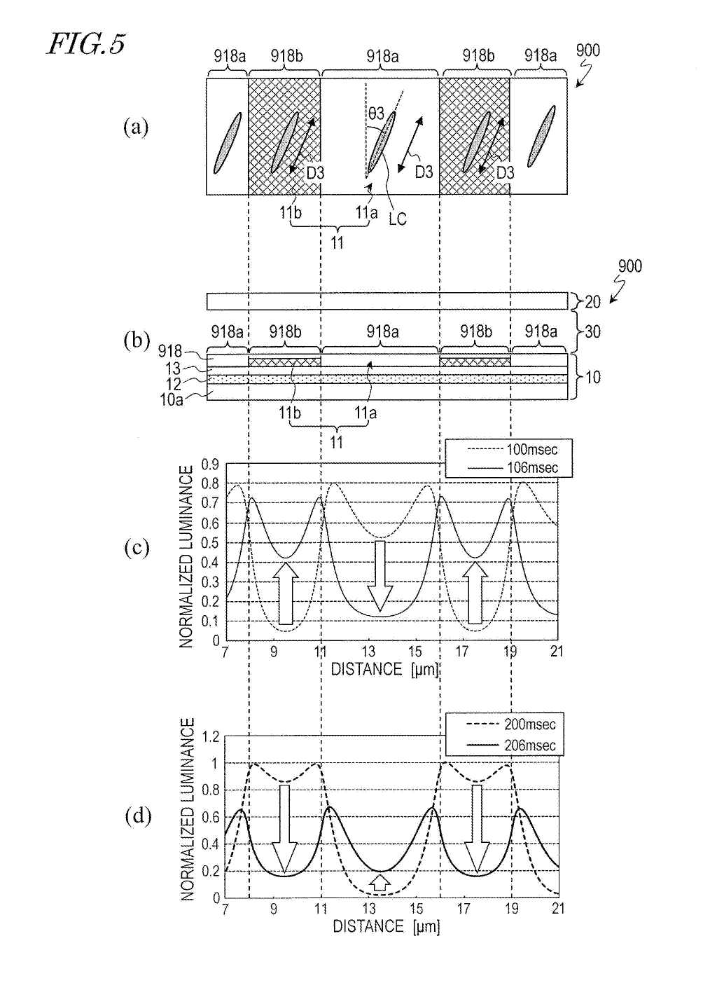

Now, with reference to FIG. 5(a) through FIG. 5(d), this will be described more specifically on the example shown in FIG. 4.

FIG. 5(a) and FIG. 5(b) are respectively a plan view and a cross-sectional view schematically showing a liquid crystal display device 900 in a comparative example. FIG. 5(a) and FIG. 5(b) correspond to FIG. 2(a) and FIG. 2(b) regarding the liquid crystal display device 100 in this embodiment. FIG. 5(c) is a graph showing a luminance profile (relationship between the relative luminance and the distance in the transverse direction (left-right direction in FIG. 5(a) and FIG. 5(b)) obtained when a positive pixel voltage is applied (at the time of 100 msec.) and a luminance profile obtained immediately after the polarity of the pixel voltage is inverted from positive to negative (at the time of 106 msec.). FIG. 5(d) is a graph showing a luminance profile obtained when a negative pixel voltage is applied (at the time of 200 msec.) and a luminance profile obtained immediately after the polarity of the pixel voltage is inverted from negative to positive (at the time of 206 msec.).

Unlike in the liquid crystal display device 100 in this embodiment, in liquid crystal display device 900 in the comparative example shown in FIG. 5(a) and FIG. 5(b), one initial alignment axis azimuth D3 is defined for the entirety of each pixel by an alignment film 918. In the liquid crystal display device 900, the initial alignment axis azimuth D3 defined by regions 918 of the alignment film 918a corresponding to the slits 11a of the pixel electrode 11 is the same as the initial alignment axis azimuth D3 defined by regions 918b of the alignment film 918 corresponding to portions of the pixel electrode 11 other than the slits 11a (mainly, lengthy electrode portions 11b). Angle θ3 made by the initial alignment axis azimuth D3 and the direction in which the slits 11a extend is 15° in this comparative example.

When a predetermined voltage is applied between the pixel electrode 11 and the common electrode 12, the liquid crystal molecules LC are in the splay alignment in the vicinity of the active matrix substrate 10, which causes flexoelectric polarization, regardless of whether the polarity of the predetermined voltage is positive or negative. The flexoelectric polarization is caused by competition between an alignment control force made by an electric field generated in the liquid crystal layer 30 and an alignment control force made by the alignment film 918 in the active matrix substrate 10. It should be noted that the direction of the flexoelectric polarization is different in accordance with whether the polarity of the pixel voltage is positive or negative. Namely, the direction of the flexoelectric polarization is inverted along with the inversion of the polarity of the pixel voltage. Immediately after the inversion of the polarity of the pixel voltage, the flexoelectric polarization is alleviated (is extinguished).

The luminance profiles shown in FIG. 5(c) and FIG. 5(d) were obtained by a simulation. As simulation software, LCD MASTER produced by Shintech Inc. was used. Flickers caused by flexoelectric polarization is easily recognized visually during low gray scale display (e.g., 64 gray scale display in a liquid crystal display device providing 256 gray scale display: corresponding to 5% of the normalized transmittance). Therefore, the pixel voltage for the simulation was set to a voltage corresponding to the 64 gray scale display (specifically, 1.35 V; see Table 2 described below). The cell thickness (thickness of the liquid crystal layer) was 3.0 and the thickness of the dielectric layer was 0.3 μm. The width of each of slits 11a and the width of each of the lengthy electrode portions 11b of the first electrode (pixel electrode) 11 were respectively 5.0 μm and 3.0 μm. The properties of the positive liquid crystal material used for the liquid crystal layer 30 were as shown in Table 1 below. In the case where the polarity of the pixel voltage is inverted, a difference may be caused between the luminance (transmittance) when a positive electrode is applied and the luminance (transmittance) when a negative electrode is applied. Such transmittance asymmetry was compensated for by applying a predetermined DC voltage to the common voltage (Vcom). In the comparative example, the offset common voltage was 0.017 V.

TABLE 1
Properties of the liquid crystal material

| Refractive index anisotropy Δn | | 0.10 | |
|---|---|---|---|
| Dielectric constant anisotropy Δε | | 7.0 | |
| Elastic modulus | K₁₁ | 15.3 | pN |
| | K₂₂ | 8.5 | pN |
| | K₃₃ | 17.6 | pN |
| Flexoelectric coefficient | e₁₁ | −30 | pC/m |
| | e₃₃ | | |

As can be seen the luminance profiles at the time of 100 msec. shown in FIG. 5(c), when the polarity of the pixel voltage is positive, regions above the slits 11a of the pixel electrode 11 are bright whereas regions above the lengthy electrode portions 11b of the pixel electrode 11 are dark. As can be seen the luminance profiles at the time of 106 msec., when the polarity of the pixel voltage is inverted from positive to negative, the luminance of the regions above the slits 11a is decreased whereas the luminance of the regions above the lengthy electrode portions 11b is increased. At this point, the degree of decrease in the luminance of the regions above the slits 11a is larger than the degree of increase in the luminance of the regions above the lengthy electrode portions 11b. Therefore, the average luminance (luminance of the entirety of the pixel Px) is decreased.

By contrast, as can be seen the luminance profiles at the time of 200 msec. shown in FIG. 5(d), when the polarity of the pixel voltage is negative, the regions above the lengthy electrode portions 11b of the pixel electrode 11 are bright whereas the regions above the slits 11a of the pixel electrode 11 are dark. As can be seen the luminance profiles at the time of 206 msec., when the polarity of the pixel voltage is inverted from negative to positive, the luminance of the regions above the lengthy electrode portions 11b is decreased whereas the luminance of the regions above the slits 11a is increased. At this point, the degree of decrease in the luminance of the regions above the lengthy electrode portions 11b is larger than the degree of increase in the luminance of the regions above the slits 11a. Therefore, the average luminance is decreased.

As described above, when the polarity of the pixel voltage is inverted, the luminance of the pixel Px is decreased, which is visually recognized as flicker. In the case where idle driving is performed, such flicker is made conspicuous.

For the above-described reason, the downward horn response (flicker) is caused by the flexoelectric polarization. In the liquid crystal display device 100 in this embodiment, the alignment film 18 includes the first regions 18a and the second regions 18b. Therefore, even if the liquid crystal display device 100 is driven at a frequency less than 60 Hz, flicker caused by the flexoelectric polarization is made difficult to be visually recognized. This was investigated by a simulation. Hereinafter, the results of the simulation will be described. For the simulation, the conditions described above (conditions used for the calculation of the luminance profiles) were used.

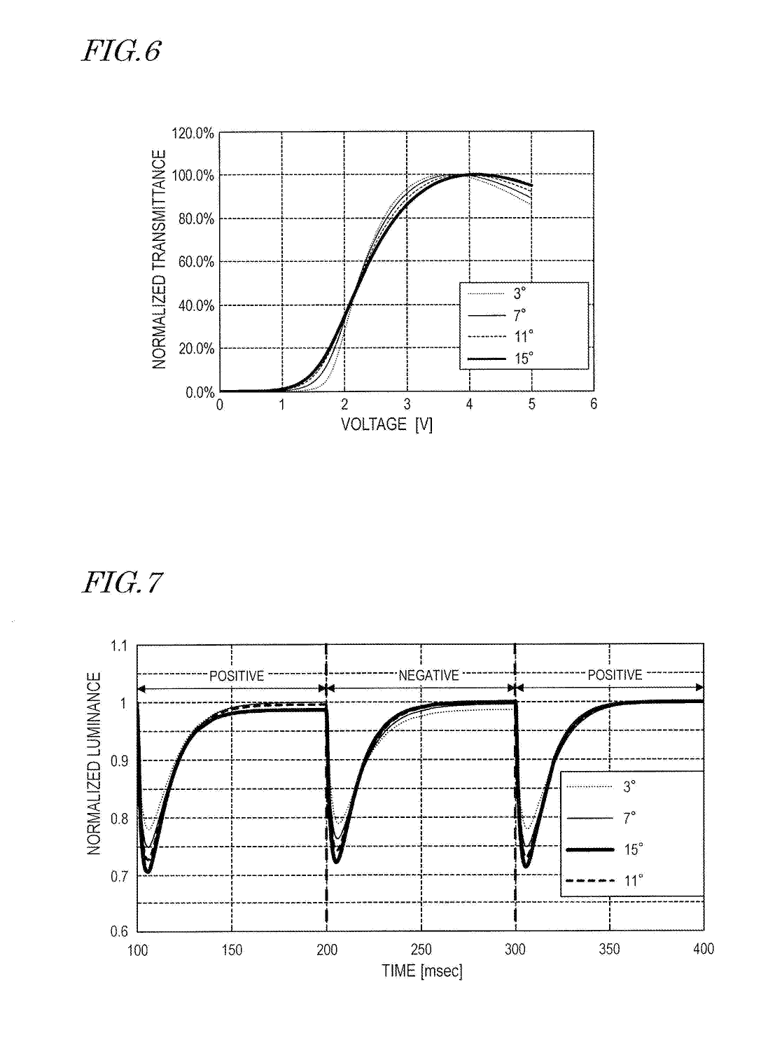

First, the dependence of the VT characteristic on the initial alignment angle was investigated by a simulation. FIG. 6 shows the VT characteristic (relationship between the pixel voltage and the normalized transmittance) obtained when the initial alignment angle (angle made by the initial alignment axis azimuth and the direction in which the slits 11a extend) is 3°, 7°, 11° and 15°.

As can be seen FIG. 6, the VT characteristic varies in accordance with the magnitude of the initial alignment angle. Specifically, as the initial alignment angle is smaller, the voltage at which the normalized transmittance is maximum is lower (namely, the voltage is lowest at 3°, second lowest at 7°, second highest at 11°, and highest at 15°).

From the results shown in FIG. 6, the voltage corresponding to each of gray scale levels is obtained. When the initial alignment angle is 3°, 7°, 11° and 15°, the voltages corresponding to the 64 gray scale display are as shown in Table 2.

TABLE 2

| Initial alignment angle | 3° | 7° | 11° | 15° |
|---|---|---|---|---|
| Voltage for 64 gray scale display | 1.71 V | 1.53 V | 1.42 V | 1.35 V |

Next, the dependence of the response characteristic on the initial alignment angle was investigated. FIG. 7 shows the response characteristic (relationship between the time and the normalized transmittance) obtained when the initial alignment angle is 3°, 7°, 11° and 15°.

As can be seen FIG. 7, the response characteristic varies in accordance with the magnitude of the initial alignment angle. Specifically, as the initial alignment angle is smaller, the degree of decrease in the luminance when the polarity of the pixel voltage is inverted is smaller (namely, the degree of decrease is smallest at 3°, second smallest at 7°, second largest at 11°, and largest at 15°).

As can be seen, the initial alignment angle may be made smaller, so that the luminance decrease immediately after the inversion of the polarity is suppressed. In the liquid crystal display device 100 in this embodiment, the alignment film 18 includes a plurality of types of regions (first regions 18a and second regions 18b) defining different initial alignment axis azimuths. Therefore, the initial alignment angle of the regions where the luminance decrease would otherwise be large may be made smaller, so that the luminance decrease is effectively suppressed. For this reason, even if the liquid crystal display device 100 in this embodiment is driven at a frequency less than 60 Hz, flicker (downward horn response) caused by flexoelectric polarization is made difficult to be visually recognized.

The mechanism by which the decrease in the initial alignment angle suppresses the luminance decrease has not been clarified. It is considered as follows: in the case where the initial alignment angle is small, the angle of backward rotation of the liquid crystal molecule LC is increased when the flexoelectric polarization is alleviated; and this increases the elasticity of the liquid crystal molecule LC, as a result of which, the time period required for the liquid crystal molecule LC to return to the original orientation is shortened, so that the luminance decrease (downward horn response) is suppressed.

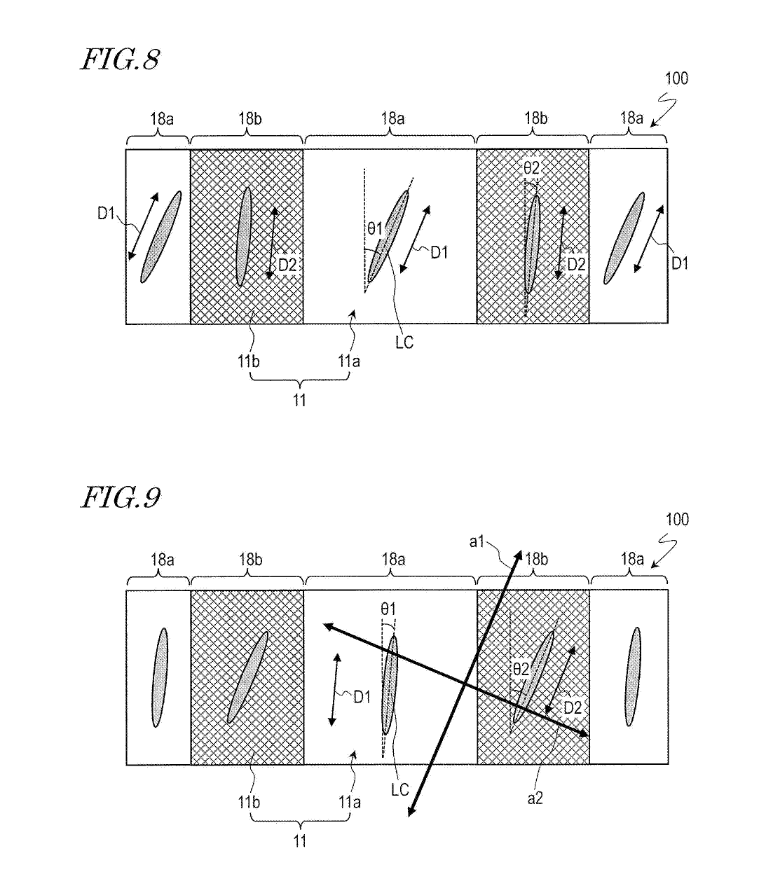

In the example shown in FIG. 2(a), the initial alignment angle θ1 in the first regions 18a of the alignment film 18 is smaller than the initial alignment angle θ2 in the second regions 18b of the alignment film 18. By contrast, as shown in FIG. 8, the initial alignment angle θ1 in the first regions 18a may be larger than the initial alignment angle θ2 in the second regions 18b.

Now, a preferable positional arrangement of the pair of polarization plates will be described.

As described above, the pair of polarization plates are located in a crossed-Nicols state. It is preferable that as shown in FIG. 9, the polarization axis a1 of one of the pair of polarization plates is approximately parallel to either the initial alignment axis azimuth D1 defined by the first regions 18a or the initial alignment axis azimuth D2 defined by the first regions 18b that makes a larger angle with respect to the direction in which the slits 11a extend (namely, in the example shown in FIG. 9, it is preferable that the polarization axis a1 is approximately parallel to the initial alignment axis azimuth D2 defined by the second regions 18b). The positional arrangement shown in FIG. 9 may be adopted, so that the brightness in the black display state is made sufficiently low to make the contrast sufficiently high.

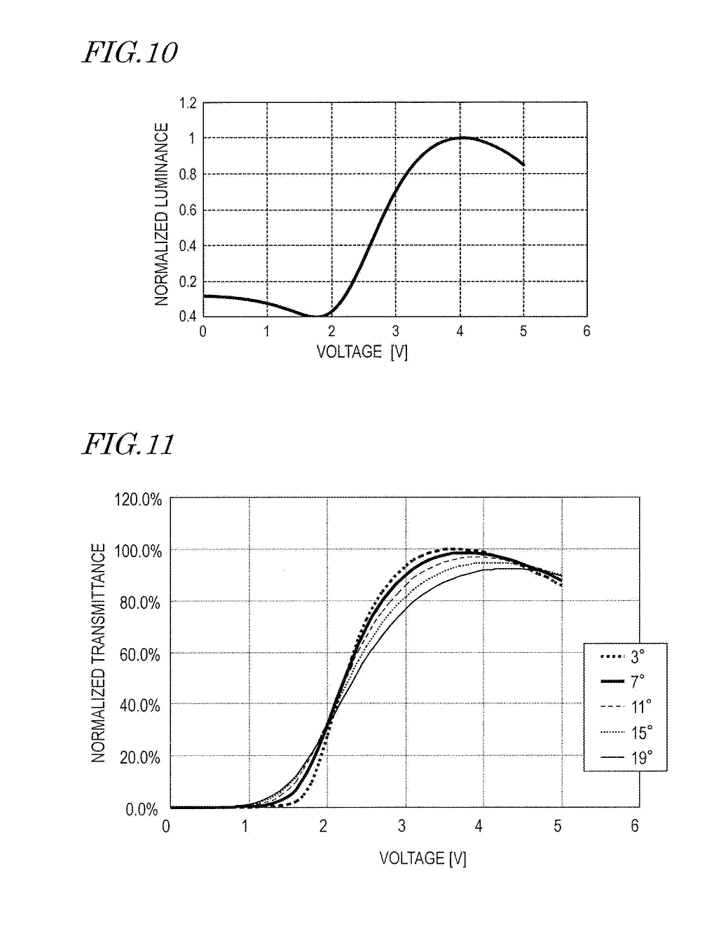

FIG. 10 shows the VT characteristic in the case where the initial alignment angle θ1 in the first regions 18a is 3°, the initial alignment angle θ2 in the second regions 18b is 15°, and the polarization axis a1 of one of the pair of polarization plates is approximately parallel to the initial alignment axis azimuth D2 defined by the second regions 18b.

As can be seen FIG. 10, while no voltage is applied, the normalized luminance is larger than zero. As the voltage is increased from 0 V, the normalized luminance is once decreased to the minimum value (almost zero) and then is increased. The normalized luminance has the minimum value when the alignment azimuth of the liquid crystal molecule LC corresponding to the first regions 18a (regions in which the initial alignment angle is smaller) matches the polarization axis a1. The voltage at this point (in the example shown in FIG. 10, about 1.8 V) may be set to a black display voltage, so that the contrast ratio is sufficiently high.

The initial alignment angle θ1 in the first regions 18a and the initial alignment angle θ2 in the second regions 18b merely need to be different from each other, and are not limited to the above-described values. It should be noted that among the initial alignment angle θ1 in the first regions 18a and the initial alignment angle θ2 in the second regions 18b, the larger angle is preferably 4° or greater and 15° or less, and the smaller angle is preferably 3° or greater and 14° or less. Hereinafter, a reason for this will be described.

First, the axis precision and the production process precision of the polarization plates are each assumed to be about ±1°. Therefore, the lower limit of each of the initial alignment angles θ1 and 02 is preferably about 3° to about 4°.

FIG. 11 shows the VT characteristic (relationship between the pixel voltage and the normalized transmittance) when the initial alignment angle is 3°, 7°, 11°, 15° and 19°. The VT characteristic shown in FIG. 11 is obtained as a result of the transmittance being normalized with respect to the maximum transmittance when the initial alignment angle is 3° being 100%.

As can be seen FIG. 11, as the angle is smaller, the maximum transmittance is higher, and the maximum transmittance is obtained at a lower voltage. For example, when the initial alignment angle is 19° as compared with when the initial alignment angle is 3°, the maximum transmittance is lower by about 8%, and the voltage at which the transmittance is maximum is higher by about 0.6 V. Therefore, the upper limit of each of the initial alignment angles θ1 and 02 is preferably about 14° to about 15° from the point of view of decreasing the power consumption. When the initial alignment angle is 15° as compared with when the initial alignment angle is 3°, the maximum transmittance is lower by about 8%, and the voltage at which the transmittance is maximum is higher by about 0.3 V. The adverse influence on the decrease in the power consumption is relatively small.

For the above-described reason, among the initial alignment angle θ1 in the first regions 18a and the initial alignment angle θ2 in the second regions 18b, the larger angle is preferably 4° or greater and 15° or less, and the smaller angle is preferably 3° or greater and 14° or less.

Regarding the liquid crystal display device 100 in an embodiment according to the present invention, the effect of suppressing the luminance decrease at the time of the polarity inversion of the pixel voltage was investigated by a simulation. Hereinafter, the results of the simulation will be described. For the simulation, the conditions described above were used.

### Example 1

First, in example 1, the investigation results obtained when the initial alignment angle θ1 in the first regions 18a (regions corresponding to the slits 11a) of the alignment film 18 is 3° and the initial alignment angle θ2 in the second regions 18b (mainly, regions corresponding to the lengthy electrode portions 11b) of the alignment film 18 is 15°. The common voltage is 0.000 V.

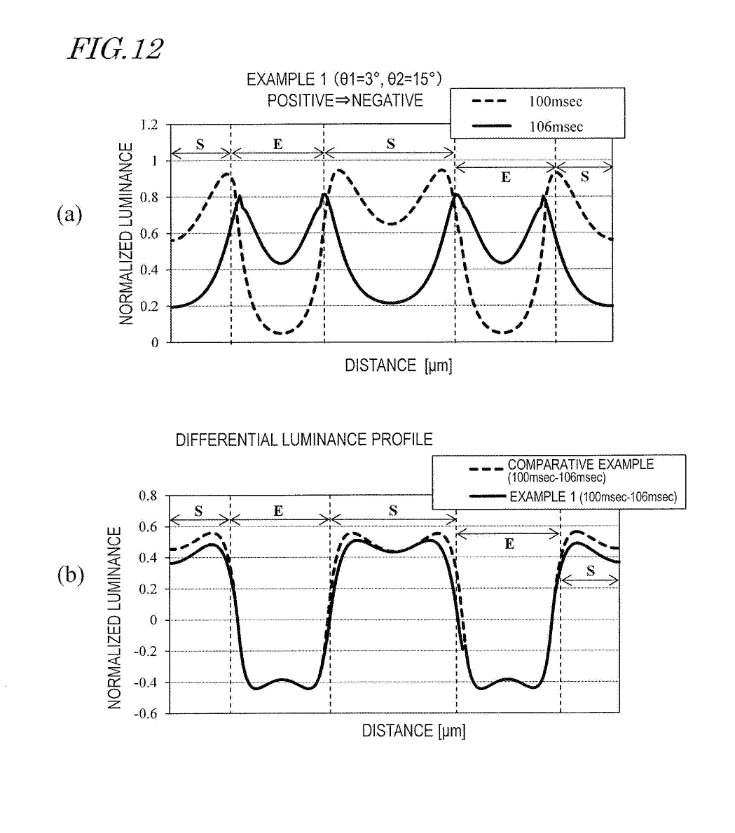

FIG. 12(a) shows a luminance profile obtained when a positive pixel voltage is applied (at the time of 100 msec.) and a luminance profile obtained immediately after the polarity of the pixel voltage is inverted from positive to negative (at the time of 106 msec.).

As can be seen FIG. 12(a), when the polarity of the pixel voltage is positive, the regions above the slits 11a of the pixel electrode 11 (regions S in FIG. 12(a)) are bright, and the regions above the lengthy electrode portions 11b (regions E in FIG. 12(a)) are dark. When the polarity of the pixel voltage is inverted from positive to negative, the luminance of the regions above the slits 11a is decreased and the luminance of the regions above the lengthy electrode portions 11b is increased. At this point, the degree of decrease in the luminance of the regions above the slits 11a is larger than the degree of increase in the luminance of the regions above the lengthy electrode portions 11b. Therefore, the average luminance is decreased. It should be noted that as can be seen from the comparison between FIG. 12(a) and FIG. 5(c), the degree of decrease in the average luminance in example 1 is smaller than the degree of decrease in the average luminance in the liquid crystal display device 900 in the comparative example.

FIG. 12(b) shows a difference between the luminance profile obtained at the time of 100 msec. and the luminance profile obtained at the time of 106 msec. of each of the liquid crystal display device 900 in the comparative example and the liquid crystal display device in example 1. As can be seen from FIG. 12(b), the degree of decrease in the average luminance is smaller in example 1 than in the liquid crystal display device 900 in the comparative example.

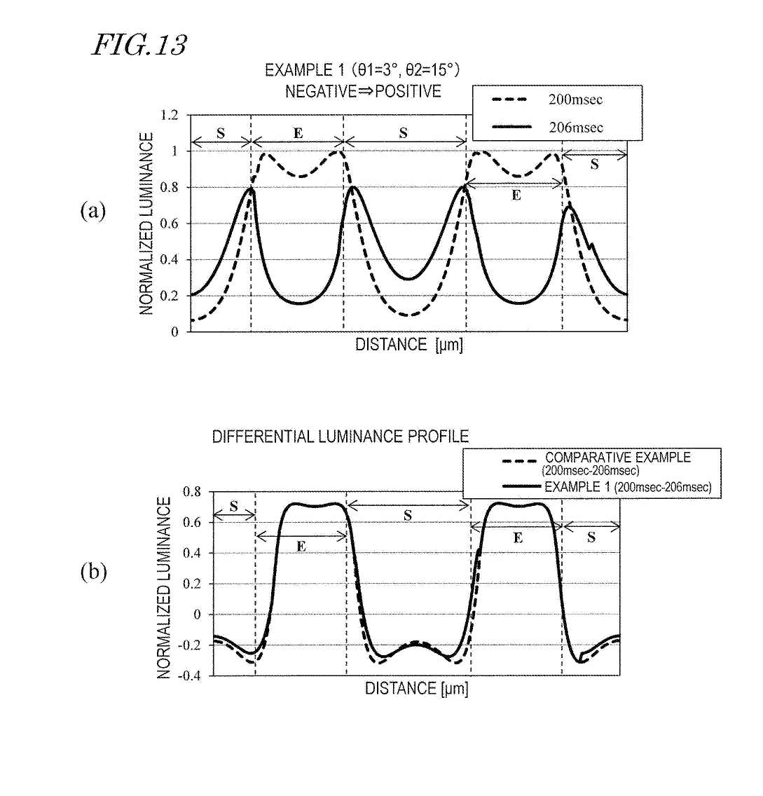

FIG. 13(a) shows a luminance profile obtained when a negative pixel voltage is applied (at the time of 200 msec.) and a luminance profile obtained immediately after the polarity of the pixel voltage is inverted from negative to positive (at the time of 206 msec.).

As can be seen FIG. 13(a), when the polarity of the pixel voltage is negative, the regions above the lengthy electrode portions 11b of the pixel electrode 11 (regions E in FIG. 13(a)) are bright, and the regions above the slits 11a (regions S in FIG. 13(a)) are dark. When the polarity of the pixel voltage is inverted from negative to positive, the luminance of the regions above the lengthy electrode portions 11b is decreased and the luminance of the regions above the slits 11a is increased. At this point, the degree of decrease in the luminance of the regions above the lengthy electrode portions 11b is larger than the degree of increase in the luminance of the regions above the slits 11a. Therefore, the average luminance is decreased. It should be noted that as can be seen from the comparison between FIG. 13(a) and FIG. 5(d), the degree of decrease in the average luminance in example 1 is smaller than the degree of decrease in the average luminance in the liquid crystal display device 900 in the comparative example.

FIG. 13(b) shows a difference between the luminance profile obtained at the time of 200 msec. and the luminance profile obtained at the time of 206 msec. of each of the liquid crystal display device 900 in the comparative example and the liquid crystal display device in example 1. As can be seen from FIG. 13(b), the degree of decrease in the average luminance is smaller in example 1 than in the liquid crystal display device 900 in the comparative example.

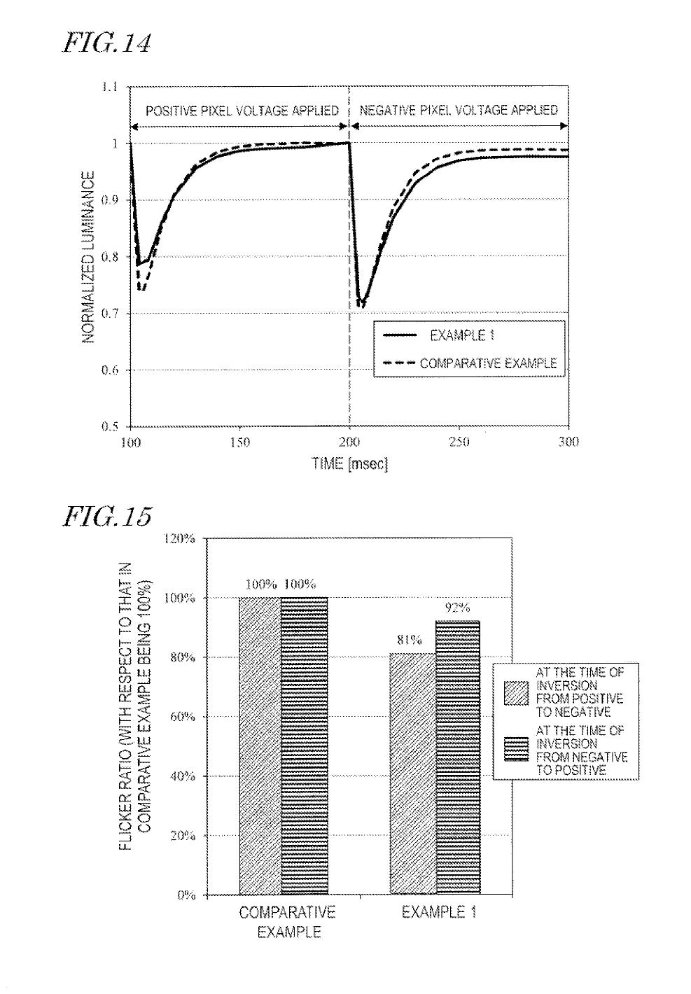

FIG. 14 shows the results of calculation made by a simulation regarding the time-wise change in the normalized luminance in the case where idle driving is performed at 10 Hz on the liquid crystal display device 900 in the comparative example and the liquid crystal display device in example 1. In this example, a negative pixel voltage is applied in the odd-numbered frames and a positive pixel voltage is applied in the even-numbered frames.

It is seen from FIG. 14 that the luminance decrease when the polarity of the pixel voltage is inverted from negative to positive and the luminance decrease when the polarity of the pixel voltage is inverted from positive to negative are both suppressed more in example 1 than in the liquid crystal display device 900 in the comparative example.

FIG. 15 shows the results of calculation of the flicker ratio in the case where idle driving is performed at 10 Hz on the liquid crystal display device 900 in the comparative example and the liquid crystal display device in example 1. The “flicker ratio” is originally a value obtained by dividing, by accumulated average transmittance Tave, the difference between the maximum value Tmax and the minimum value Tmin of the transmittance (normalized transmittance), namely, ΔT (=Tmax-Tmin). FIG. 15 shows the flicker ratio as a relative value with respect to the flicker ratio in the comparative example being 100%.

As can be seen from FIG. 15, the flicker ratio is lower in example 1 than in the liquid crystal display device 900 in comparative example. In example 1, the flicker ratio is alleviated by 8% to 19%.

### Example 2

Now, in example 2, the investigation results obtained when the initial alignment angle θ1 in the first regions 18a (regions corresponding to the slits 11a) of the alignment film 18 is 7° and the initial alignment angle θ2 in the second regions 18b (mainly, regions corresponding to the lengthy electrode portions 11b) of the alignment film 18 is 3°. The common voltage is 0.020 V.

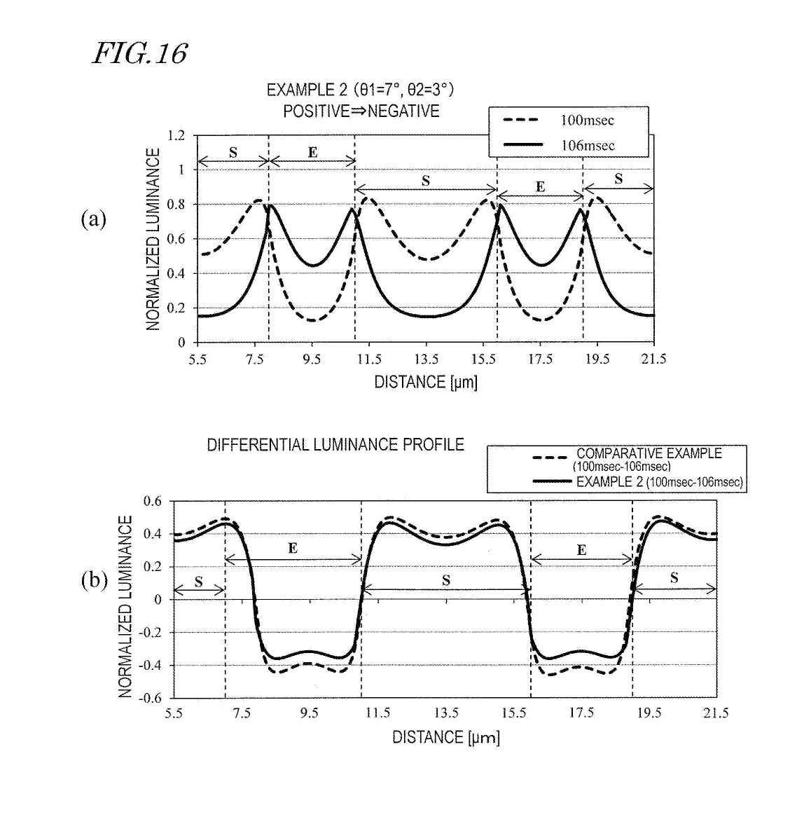

FIG. 16(a) shows a luminance profile obtained when a positive pixel voltage is applied (at the time of 100 msec.) and a luminance profile obtained immediately after the polarity of the pixel voltage is inverted from positive to negative (at the time of 106 msec.).

As can be seen FIG. 16(a), when the polarity of the pixel voltage is positive, the regions above the slits 11a of the pixel electrode 11 (regions S in FIG. 16(a)) are bright, and the regions above the lengthy electrode portions 11b (regions E in FIG. 16(a)) are dark. When the polarity of the pixel voltage is inverted from positive to negative, the luminance of the regions above the slits 11a is decreased and the luminance of the regions above the lengthy electrode portions 11b is increased. At this point, the degree of decrease in the luminance of the regions above the slits 11a is larger than the degree of increase in the luminance of the regions above the lengthy electrode portions 11b. Therefore, the average luminance is decreased. It should be noted that as can be seen from the comparison between FIG. 16(a) and FIG. 5(c), the degree of decrease in the average luminance in example 2 is smaller than the degree of decrease in the average luminance in the liquid crystal display device 900 in the comparative example.

FIG. 16(b) shows a difference between the luminance profile obtained at the time of 100 msec. and the luminance profile obtained at the time of 106 msec. of each of the liquid crystal display device 900 in the comparative example and the liquid crystal display device in example 2. As can be seen from FIG. 16(b), the degree of decrease in the average luminance is smaller in example 2 than in the liquid crystal display device 900 in the comparative example.

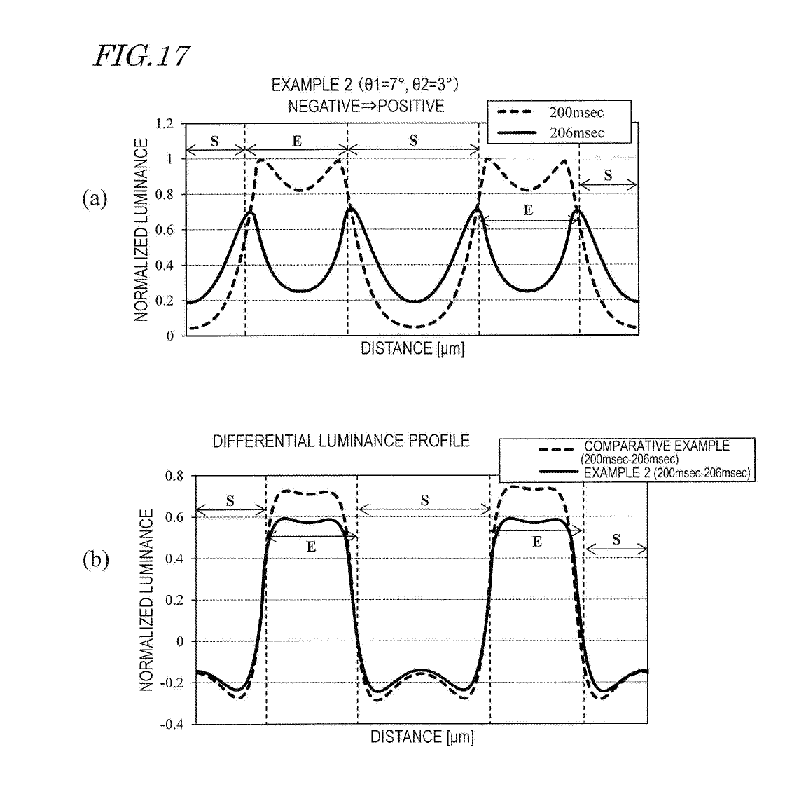

FIG. 17(a) shows a luminance profile obtained when a negative pixel voltage is applied (at the time of 200 msec.) and a luminance profile obtained immediately after the polarity of the pixel voltage is inverted from negative to positive (at the time of 206 msec.).

As can be seen FIG. 17(a), when the polarity of the pixel voltage is negative, the regions above the lengthy electrode portions 11b of the pixel electrode 11 (regions E in FIG. 17(a)) are bright, and the regions above the slits 11a (regions S in FIG. 17(a)) are dark. When the polarity of the pixel voltage is inverted from negative to positive, the luminance of the regions above the lengthy electrode portions 11b is decreased and the luminance of the regions above the slits 11a is increased. At this point, the degree of decrease in the luminance of the regions above the lengthy electrode portions 11b is larger than the degree of increase in the luminance of the regions above the slits 11a. Therefore, the average luminance is decreased. It should be noted that as can be seen from the comparison between FIG. 17(a) and FIG. 5(d), the degree of decrease in the average luminance in example 2 is smaller than the degree of decrease in the average luminance in the liquid crystal display device 900 in the comparative example.

FIG. 17(b) shows a difference between the luminance profile obtained at the time of 200 msec. and the luminance profile obtained at the time of 206 msec. of each of the liquid crystal display device 900 in the comparative example and the liquid crystal display device in example 2. As can be seen from FIG. 17(b), the degree of decrease in the average luminance is smaller in example 2 than in the liquid crystal display device 900 in the comparative example.

FIG. 18 shows the results of calculation made by a simulation regarding the time-wise change in the normalized luminance in the case where idle driving is performed at 10 Hz on the liquid crystal display device 900 in the comparative example and the liquid crystal display device in example 2. In this example, a negative pixel voltage is applied in the odd-numbered frames and a positive pixel voltage is applied in the even-numbered frames.

It is seen from FIG. 18 that the luminance decrease when the polarity of the pixel voltage is inverted from negative to positive and the luminance decrease when the polarity of the pixel voltage is inverted from positive to negative are both suppressed more in example 2 than in the liquid crystal display device 900 in the comparative example.

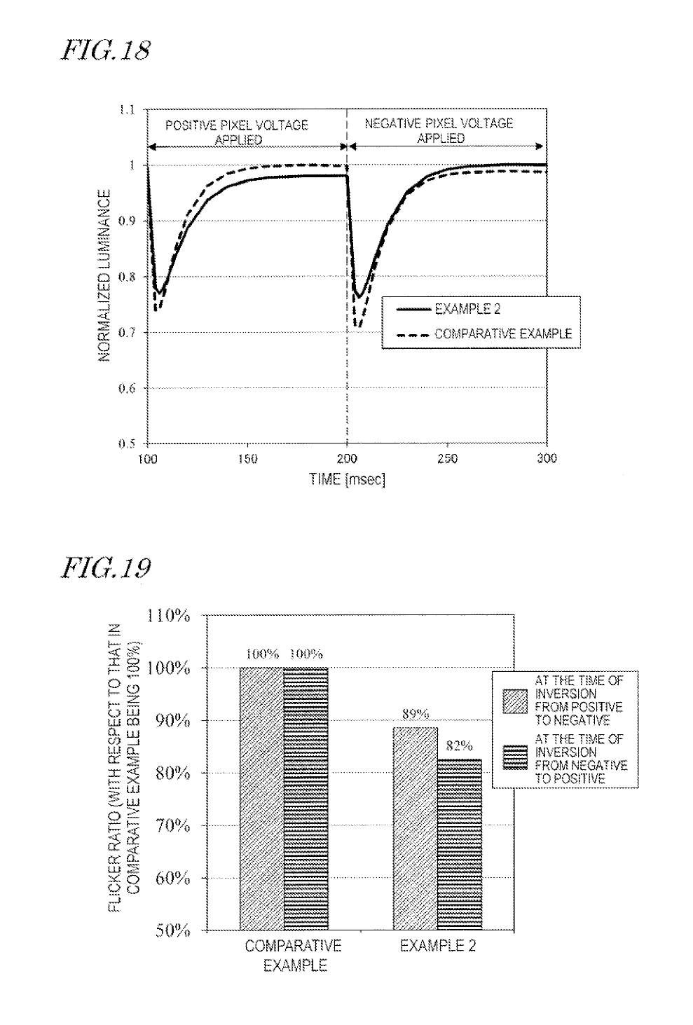

FIG. 19 shows the results of calculation of the flicker ratio in the case where idle driving is performed at 10 Hz on the liquid crystal display device 900 in the comparative example and the liquid crystal display device in example 2. FIG. 19 also shows the flicker ratio as a relative value with respect to the flicker ratio in the comparative example being 100%.

As can be seen from FIG. 19, the flicker ratio is lower in example 2 than in the liquid crystal display device 900 in comparative example. In example 2, the flicker ratio is alleviated by 11% to 18%.

(Production method)

Now, a method for producing the liquid crystal display device 100 in an embodiment according to the present invention will be described.

The active matrix substrate 10 may be produced by any of various known methods. The gate metal layer (including the gate electrode of the TFT and the scanning line) and the source metal layer (including the source electrode and the drain electrode of the TFT and the signal line) are each formed of, for example, a TiN/Tl/TiN stacked film having a thickness of 0.4 μm. The gate insulating layer 14 and the dielectric layer 13 are each formed of, for example, an SiNₓ film having a thickness of 0.2 μm to 0.5 μm. The protective layer 16 is formed of, for example, an SiNdₓ film having a thickness of 0.4 μm. The organic interlayer insulating layer 17 is formed of, for example, an acrylic resin material having a thickness of 2.5 μm. The first electrode (pixel electrode) 11 and the second electrode (common electrode) 12 are each formed of, for example, an ITO film having a thickness of 0.1 μm.

The lengthy electrode portions 11b of the first electrode 11 each have a width of, for example, 3.0 μm. Gaps between the lengthy electrode portions 11b (slits 11a) each have a width of, for example, 5.0 μm.

The counter substrate 20 may be formed of any of various known methods. The light blocking layer 21 is formed of, for example, a black resin material and has a thickness of, for example, 1.6 μm. The red color filter 22R, the green color filter 22G and the blue color filter 22B are each formed of, for example, a colored resin material and each have a thickness of, for example, 1.5 μm. The organic flattening layer 23 is formed of, for example, an acrylic resin material and has a thickness of, for example, 2.0 μm. The transparent conductive layer 26 is formed of, for example, an ITO film having a thickness of 20 nm. The transparent conductive layer 26 is formed by, for example, sputtering after the step of injecting the liquid crystal material.

The alignment films 18 and 28, which are optical alignment films, may be formed as follows, for example. First, an optical alignment film material is applied to surfaces of the active matrix substrate 10 and the counter substrate 20 by spin-coating or the like and baked to form the alignment films 18 and 28 each having a thickness of, for example, 0.06 μm to 0.08 μm.

More specifically, the alignment films 18 and 28 may be formed as follows. A PVCi (poly(vinyl cinnamate))-based optical alignment film material is mixed with -butyrolactone such that the concentration of a solid content is 3.0% by weight. The resultant solution is applied to the active matrix substrate 10 and the counter substrate 20 each located on a spin coater while the rotation rate of the spin coater is adjusted such that the resultant films each have a thickness of 60 nm to 80 nm (e.g., 1500 rpm to 2500 rpm). Next, the substrates are subjected to a baking process of pre-baking the substrates on a hot plate (e.g., at 80° C. for 1 minute) and post-baking the substrates (e.g., at 180° C. for 1 hour).

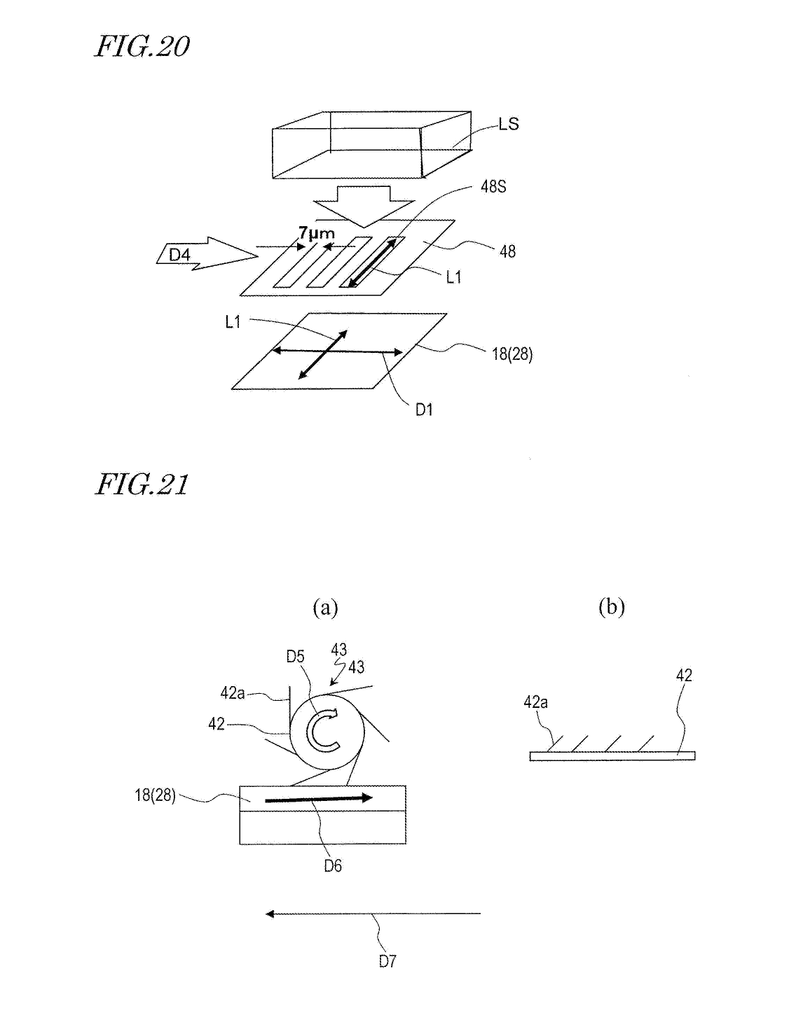

Then, as shown in FIG. 20, each of the alignment films 18 and 28 is irradiated with linearly polarized ultraviolet light (polarized UV) having polarization direction L1 through a mask (wire grid slit mask) 48 including a plurality of slits 48S extending in a predetermined direction. As a result, the optical alignment films 18 and 28 are obtained. For example, the mask 48 including slits 48s each having a width of about 7 μm is located between a UV light source LS and the alignment films 18 and 28, and each of the alignment films 18 and 28 is irradiated with the polarized UV with an irradiation energy being set to 1.5 J/cm². At this point, the substrates are scanned in a predetermined direction D4 at a rate of, for example, 35 μm/sec., so that an optical alignment process is performed on the entirety of the resin film. In this example, an optical alignment film material expressing an alignment control force in a direction perpendicular to the polarization direction L1 of the polarized UV (the direction perpendicular to the polarization direction L1 is represented by the alignment axis azimuth D1) is used.

In the display device 100 in this embodiment according to the present invention, the above-described exposure step on the optical alignment film 18 is performed twice so that two types of regions defining the initial alignment axis azimuths D1 and D2 different from each other (first regions 18a and second regions 18b) are formed. Specifically, exposure is performed in a state where the alignment film 18 and the wire grid mask 48 have, therebetween, another mask (not shown) including openings corresponding to the regions corresponding to the slits 11a of the first electrode 11. After this (or before this), exposure is performed in a state where the alignment film 18 and the wire grid mask 48 have, therebetween, a different mask (not shown) including openings corresponding to the regions corresponding to the portions of the first electrode 11 other than the slits 11a. The polarization direction L1 of the polarized UV in each cycle of the exposure step is set such that the initial alignment axis azimuths D1 and D2 defined by the first regions 18a and the second regions 18b are respectively desirable azimuths. Similarly, the exposure step is performed twice on the optical alignment film 28.

In this manner, the alignment films 18 and 28, which are optical alignment films, are formed. The alignment films 18 and 28 do not need to be optical alignment films. For example, the alignment films 18 and 28 may be treated with a rubbing process as an alignment process. The alignment films 18 and 28 treated with a rubbing process may be formed as follows, for example.

First, a polyamic acid-based alignment film material is mixed with -butyrolactone such that the concentration of a solid content is 3.0% by weight. The resultant solution is applied to the active matrix substrate 10 and the counter substrate 20 each located on a spin coater while the rotation rate of the spin coater is adjusted such that the resultant films each have a thickness of 60 nm to 80 nm (e.g., 1500 rpm to 2500 rpm). Next, the substrates are subjected to a baking process of pre-baking the substrates on a hot plate (e.g., at 80° C. for 1 minute) and post-baking the substrates (e.g., at 180° C. for 1 hour).

Then, as shown in FIG. 21(a), the alignment films 18 and 28 are treated with a rubbing process by use of a rubbing roller 43 having a rubbing cloth 42 wound therearound. The rubbing process is performed by use of YA18R (material: rayon) produced by Yoshikawa Chemical Co., Ltd. as the rubbing cloth 42 under the conditions that the rotation rate of the robbing roller 43 is 300 rpm, the moving rate of the stage is 25 mm/min., and the rubbing cloth 42 is pressed into the rubbing roller 43 by 0.6 μm. A rotation direction D5 of the robbing roller 43, a rubbing direction D6 of the robbing roller 43 and a moving direction D7 of the stage have the relationship shown in FIG. 21(a). As shown in FIG. 21(b), filaments 42a of the rubbing cloth 42 are inclined. In the example shown in FIG. 21(a), so-called forward rubbing is performed, namely, the rubbing is performed such that the filaments 42a are each laid on a portion of the surface of the rubbing roller 43 that makes an acute angle with the filament 42a. In the transverse electric field mode, it is preferable that the alignment films 18 and 28 have a relatively strong anchoring characteristic. For example, the moving rate of the stage may be decreased, so that the rubbing density is increased to strengthen the anchoring characteristic.

In the display device 100 in an embodiment according to the present invention, the above-described rubbing process on the optical alignment film 18 is performed twice such that two types of regions defining the initial alignment axis azimuths D1 and D2 different from each other (first regions 18a and second regions 18b) are formed. For example, first, the entirety of the alignment film 18a is rubbed in the rubbing direction D6 corresponding to the initial alignment axis azimuth D1 defined by the first regions 18a. Next, in the state where the first regions 18a of the alignment film 18 are protected by a resist pattern, the alignment film 18a is rubbed in the rubbing direction D6 corresponding to the initial alignment axis azimuth D2 defined by the second regions 18b. Then, the resist pattern is peeled off. In this manner, the rubbing process is performed twice, so that the first regions 18a and the second regions 18b are respectively provided with alignment control forces defining the initial alignment axis azimuths D1 and D2 different from each other. Similarly, the rubbing process is performed twice on the alignment film 28.

After the active matrix substrate 10 and the counter substrate 20 are produced as described above, a liquid crystal material is enclosed in a gap between the substrates. Thus, a liquid crystal panel including the liquid crystal layer 30 is obtained. This step may also be performed by any of various known methods. Hereinafter, a specific example will be described. First, a sealing material is applied to an area of the counter substrate 20 that is around a region corresponding to one panel. The sealing material may be, for example, a thermosetting resin.

Next, a pre-baking step is performed (e.g., at 80° C. for 5 minutes). Spherical spacers having a desirable diameter (e.g., 3.3 μm) are scattered in a dry state on the active matrix substrate 10. Then, the active matrix substrate 10 and the counter substrate 20 are bonded together. The resultant assembly is subjected to a vacuum pressing step or a rigid pressing step, and then is subjected to a post-baking step (e.g., at 180° C. for 60 minutes).

In general, a plurality of liquid crystal panels are produced at the same time by use of a large mother glass. Therefore, after the active matrix substrate 10 and the counter substrate 20 are bonded together, the resultant assembly is divided into individual liquid crystal panels by a cutting step.

Each of the liquid crystal panels includes a space maintained by the spacers between the substrates. Namely, the liquid crystal panel is in the state of an empty cell. A liquid crystal material is injected into the empty cell. The step of injecting the liquid crystal material is performed as follows. An appropriate amount of the liquid crystal material is put into an injection dish, and the injection dish is set in a vacuum chamber together with the empty cell. After the inner pressure of the vacuum chamber is decreased to a vacuum level (e.g., for 60 minutes), the liquid crystal material is injected by dipping (e.g., for 60 minutes). After the cell having the liquid crystal material injected thereto is removed from the vacuum chamber, the liquid crystal material attached to an injection opening is cleaned away. A UV resin is applied to the injection opening and is irradiated with UV to be cured. As a result, the injection opening is sealed, and thus the liquid crystal panel is completed.

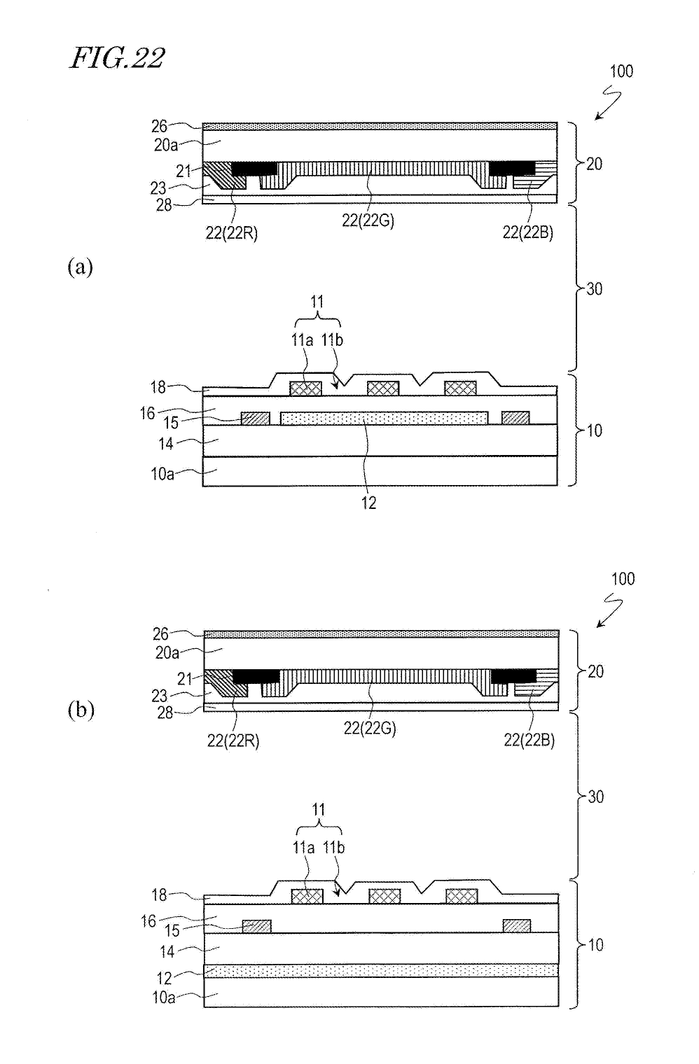

An embodiment according to the present invention has been described in the above. Needless to say, the present invention may be modified in various manners. For example, as shown in FIG. 22(a), the second electrode (common electrode) 12 may be provided in the same layer as the source metal layer (including the signal line 15 and the source electrode and the drain electrode of the TFT). In this structure, the protective layer 16 acts as a dielectric layer of a storage capacitance (i.e., dielectric layer located between the pixel electrode 11 and the common electrode 12).

Alternatively, as shown in FIG. 22(b), the second electrode (common electrode) 12 may be provided in the same layer as the gate metal layer (including the scanning line and the gate electrode of the TFT). In this structure, the gate insulating layer 14 and the protective layer 16 act as a dielectric layer of a storage capacitance (i.e., dielectric layer located between the pixel electrode 11 and the common electrode 12).

The transmission axis and the absorption axis of each of the pair of polarization plates may be exchanged with each other. In this specification, the “polarization axis” may refer to either one of the absorption axis and the transmission axis.

In the above, the liquid crystal display device of the FFS mode is described. A liquid crystal display device in an embodiment according to the present invention may be of an IPS mode.

### INDUSTRIAL APPLICABILITY

An embodiment according to the present invention is widely applicable to a liquid crystal display device of a transverse electric field mode.

### REFERENCE SIGNS LIST

10 First substrate (active matrix substrate)
11 First electrode (pixel electrode)
11a Slit
11b Lengthy electrode portion
11c Connection portion
12 Second electrode (common electrode)
13 Dielectric layer
14 Gate insulating layer
15 Signal line (source bus line)
16 Protective layer
17 Organic interlayer insulating layer
18 Alignment film
18a First region
18b Second region
20 Second substrate (counter substrate)
21 Light blocking layer (black matrix)
22 Color filter layer
22R Red color filter
22G Green color filter
22B Blue color filter
23 Organic flattening layer
26 Transparent conductive layer
28 Alignment film
30 Liquid crystal layer
100, 200 Liquid crystal display device
D1, D2 Initial alignment axis azimuth
LC Liquid crystal molecule
Px Pixel
Px1 First pixel
Px2 Second pixel
θ1, θ2 Initial alignment angle

1. A liquid crystal display device, comprising:
a first substrate and a second substrate provided so as to face each other; and
a liquid crystal layer provided between the first substrate and the second substrate;
the liquid crystal display device including a plurality of pixels arrayed in a matrix;
wherein:
the first substrate includes a first electrode and a second electrode capable of generating a transverse electric field in the liquid crystal layer, and an alignment film provided so as to be in contact with the liquid crystal layer, the alignment film defining an initial alignment axis azimuth as an alignment axis azimuth of a liquid crystal molecule while no electric field is applied to the liquid crystal layer;
the first electrode includes at least one slit;
in each of the plurality of pixels, the alignment film includes a first region corresponding to the at least one slit of the first electrode and a second region corresponding to a portion of the first electrode other than the at least one slit; and
the initial alignment axis azimuth defined by the first region of the alignment film and the initial alignment axis azimuth defined by the second region of the alignment film are different from each other.

2. The liquid crystal display device according to claim 1, further comprising a pair of polarization plates facing each other while having at least the liquid crystal layer therebetween;
wherein:
the pair of polarization plates are located in a crossed-Nicols state; and
a polarization axis of one of the pair of polarization plates is approximately parallel to either the initial alignment axis azimuth defined by the first region or the initial alignment axis azimuth defined by the second region that makes a larger angle with a direction in which the at least one slit extends.

3. The liquid crystal display device according to claim 1, wherein among an angle made by the initial alignment axis azimuth defined by the first region and a direction in which the at least one slit extends and an angle made by the initial alignment axis azimuth defined by the second region and the direction in which the at least one slit extends, the larger angle is 4° or greater and 15° or less, and the smaller angle is 3° or greater and 14° or less.

4. The liquid crystal display device according to claim 1, wherein:
the first electrode is provided on the second electrode with a dielectric layer being provided between the first electrode and the second electrode; and
the first substrate includes the alignment film, the first electrode, the dielectric layer and the second electrode provided sequentially in this order from the side of the liquid crystal layer.

5. The liquid crystal display device according to claim 1, wherein the liquid crystal display device is allowed to perform idle driving by which one frame includes a signal supply period in which a display signal voltage is supplied to each of the plurality of pixels and an idle period in which no display signal voltage is supplied to each of the plurality of pixels.

6. The liquid crystal display device according to claim 1, wherein:
the first substrate includes a thin film transistor provided in each of the plurality of pixels; and
the thin film transistor includes a semiconductor layer containing an oxide semiconductor.

7. The liquid crystal display device according to claim 6, wherein the oxide semiconductor contains an In—Ga—Zn—O-based semiconductor.

8. The liquid crystal display device according to claim 7, wherein the In—Ga—Zn—O-based semiconductor includes a crystalline portion.
